(19) United States
(12) Patent Application Publication
(10) Pub. No.: US 2005/0198173 A1
(43) Pub. Date: Sep. 8, 2005

(54) System and method for controlling receipt of electronic messages

(76) Inventor: Alexander W. Evans, New York, NY (US)

Correspondence Address: ALEXANDER W. EVANS, BOX 408 PRINCE STATION, NEW YORK, NY, 10012, US

(21) Appl. No.: 11/026,298

(22) Filed: Dec. 30, 2004

Related U.S. Application Data
(60) Provisional application No. 60/533,995, filed on Jan. 2, 2004.

(51) Int. Cl. G06F 15/16

(52) U.S. Cl. 709/206

(57) ABSTRACT

A system and method for controlling receipt of electronic messages by considering permission authorization information which may be associated with, or transmitted in or with the electronic messages, is provided. The permission authorization information may also take the form of an alias for recipients' actual messaging addresses. A user-defined profile may store the permission authorization information, other related information, and associated validation rules to be considered. Permission authorization information, rules, and/or other related information may be considered within a context of other rules and other supporting information, including sender whitelists and blacklists, address books, buddy lists, contact databases, and other data. Permission authorization information, other related information, and rules may be added automatically as messages arrive or may be predetermined by the user, may be modified automatically or by the user, and may be made to expire automatically or by the user.

This application claims the benefit of U.S. Provisional No. 60/533,995 with filing date Jan. 2, 2004.

### BACKGROUND OF THE INVENTION

The extremely low cost and nearly unlimited scalability of electronic messaging, such as e-mail, instant messaging, SMS messaging, and other types, as well as message forums such as group bulletin boards and web logs (“blogs”), has led to an explosion of messages unwanted by the recipients, typically containing unrequested commercial solicitations. In the case of e-mail messages this is often called “spam”; and in the case of instant messaging, “spim”. (Herein, the term “spam” shall be used to refer to any unrequested or undesired electronic message in any medium.) While the problem of spam has become severe and widely known in the case of e-mail messages, it is also in danger of overwhelming users of and systems for instant messaging, SMS and other wireless messaging, and other types of electronic messaging, particularly as Global Positioning System (GPS) and similar technologies are used to trigger the sending of localized commercial messages to individuals. Spam is an increasing problem on bulletin boards, web logs, and other group message forums as well.

The cost of spam in lost productivity in the United States alone has been estimated at $20 billion per year as of 2003.

A variety of techniques have been applied to curtail the incidence of unwanted electronic messages from the recipient's point of view. These are generally of two types. The first is content-based techniques, and it involves some combination of a) statistical analysis of large quantities messages and b) identification of specific unwanted messages (by users), to detect or identify content patterns or “signatures” consistent with messages sent in bulk. For example, messages relating to “free Viagra” (a popular pharmaceutical) might be so identified, via a combination of statistical content analysis and user feedback, within a particular message-receiving system. Then, when an individual message arrives at such a message-receiving system and is statistically or otherwise similar in content, pattern or signature to a known unwanted (or presumed unwanted) bulk message or type of bulk message, the individual message is identified as spam and then rejected, or otherwise processed distinctly from other, presumably desirable messages.

The second type is sender-identification-based techniques. Senders and/or points or routes of message origination are whitelisted or blacklisted. In the former case, if a sender's identity and/or the origin of or path taken by the message (as defined by data in or accompanying the message) matches an entry on the recipient's list of preapproved senders, routes and/or origins (a “whitelist”), the message is accepted, typically without any further testing. All other, “non-whitelist” messages are discarded, or otherwise processed in a different way. In the latter case, if a sender's identity (as defined in or along with the message), or the origin of or path taken by the message (such as one or more Internet addresses through which it was transmitted), matches an entry on a list of known-unacceptable senders, routes and/or origins (a “blacklist”), the message is rejected or otherwise distinctly processed from other, presumably desirable messages. All other, “non-blacklist” messages are received and processed normally.

A third, less widely used spam-prevention technique is to require an incoming message to contain some form of predetermined authorization code. Messages containing a valid authorization code are deemed acceptable by the message-receiving system, and those without are rejected or otherwise processed distinctly from other, presumably desirable messages. In one variation of this technique, a recipient's message-receiving system will request an unknown sender, or sender's messaging-sending system, to respond with some form of authorization or validation information before one or more messages will be accepted from that sender. This variation is commonly termed “challenge-response”.

The related art teaches various permutations and combinations of these basic techniques.

However, for each variant of these techniques, senders of unwanted messages have developed ever-more-sophisticated countermeasures, including falsifying the sender's identity, message origin and path; originating or relaying messages through “hi-jacked” non-blacklisted computers and other electronic systems; altering or disguising the statistical “signature” of messages through clever modification of messages' content; obtaining address and (as applicable) authorization code information through trial-and-error or subterfuge, and other methods.

The incidence of unwanted messages has thus continued to explode to increasingly unmanageable levels, leading some knowledgeable in the art to suggest publicly that electronic messages, particularly e-mails, are ceasing to be useful, particularly for transmittal of legitimate and presumably desired commercial messages.

One of the most egregious uses of spam is presently called “spoofing” or “phishing,” in which a sender sends a message pretending to originate from another, legitimate entity with whom the recipient is presumed to have an existing relationship, in order to trick the recipient into taking an action such as visiting a corresponding spoofed web site and entering his/her private log-on or other personal information there. The sender can then use this purloined information to take actions—typically having financial repercussions—in the name of the recipient of the spoof. This form of spam adds a substantial fraud- and theft-related cost to the already high cost of lost productivity.

Parties seeking to transmit a spam message to one or more recipients have at least the following challenges. First, obtain a valid message delivery address, such as an e-mail address or instant messaging address, for the recipient. (It should be noted, however, that the low cost of electronic messaging makes it practical for senders to send messages to randomly or semi-randomly composed addresses, knowing that a certain portion of such addresses will likely be legitimate.) Second, provide a sender identifier and/or sending route which is believed by the recipient's message-receiving system to be legitimate or otherwise acceptable. Third, adjust the content of the message in such as way as to make it seem other than spam, and to make it appear that the message is not one among a large quantity of like messages sent in bulk. Finally, if one or more authorization codes or other authorizing features or content is required to appear within the message, sending parties must obtain the one or more valid authorization codes or other content, and must assure that the message contains any other required authorizing features.

Of the aforesaid spam-defense approaches, whitelists are theoretically the most rigorous and stringent solution for eliminating receipt of unwanted messages. However, the whitelist approach suffers from several critical drawbacks. First, users must manage and administer evolving lists of permissions for all current and potential legitimate, desired senders, lest desired messages be deemed spam by the users' message-receiving systems and be blocked, discarded, or miscategorized. As whitelists age, the user must also prune them to remove no-longer-wanted senders. Whitelist management and administration add multiple steps to the process of purchasing goods or services from an e-commerce vendor, to registration for electronic newsletters, and to establishing electronic communications with new persons and entities. Whitelists are also unusable when a user has a need to receive occasional messages from unspecific sources, such as from the public. Whitelists also typically require the user to know a precise sender identifier, which is not always possible, particularly in electronic commerce and information publishing situations. Finally, as whitelists become increasingly long, the computational intensity to process all incoming messages against whitelists' permissions can introduce commercially unacceptable delays in the process of message processing, and/or commercially unacceptable levels of processing cost.

It is desireable, and is an object of the present invention, to make whitelist-based approaches more flexible, self-managing and self-administering, thereby to eliminate or minimize the above drawbacks and limitations.

Authorization code approaches are a close second to whitelists in rigor, stringency, and overall effectiveness. Authorization codes, however, suffer from two critical drawbacks. First is the challenge of managing and administrating evolving lists of senders, codes, and so on, although such lists are typically shorter than whitelists because a single authorization code may be applied to a large number of senders. The second is the challenge of communicating one or more codes to a variety of potential legitimate and desirable senders (and not to illegitimate or undesirable ones). Codes in an initially limited distribution may also become compromised over time, forcing users to “recall” old codes (if they can) and distribute new ones.

It is desireable, and is an object of the present invention, to make authorization-code-based approaches more flexible, self-managing and self-administering, thereby to eliminate or minimize the above drawbacks and limitations.

As a result of the aforesaid drawbacks and limitations, the rate of adoption of whitelist and authorization-code approaches has been severely limited. Most commercial spam prevention efforts to date have therefore focused on content-based approaches, supplemented by blacklists. But content-based approaches are typically far less effective than whitelist and authorization-code approaches, as spam-senders find increasingly sophisticated ways to “trick” spam-filtering and spam-blocking systems. Blacklists help, but because the number of potential senders (both truly and falsely identified in messages) is so vast, hi-jacking of legitimate sender equipment is so prevalent, and new identities are so easily created, blacklists are typically managed not by individual users or organizational message system administrators, but by underlying messaging, communications, and Internet service providers targeting “high risk” message routes and servers. As a result, blacklist approaches have merely cut down on the overall rate of growth of spam.

Accordingly, the present invention is directed to providing a solution to the problem of spam, having all the major advantages of whitelist and authorization code approaches, and certain additional advantages, without any of the major limitations.

### DESCRIPTION OF THE RELATED ART

U.S. Pat. No. 6,052,709 to Paul teaches the use of dummy email addresses to centrally capture spam messages for analysis; users' message-receiving servers' and terminals' spam-filters are centrally updated in accordance with the identification of new spam messages via said analysis, so as to block users' receipt of similar spam messages in the future. In addition to the aforesaid general limitations, it includes the drawbacks of 1) not being easily adapted to the message-receipt preferences of individual users; 2) requiring central administration (and associated administrators); and 3) and relying on statistical/probabilistic filtering, which cannot block unwanted messages as rigorously as, for example, whitelists, and sometimes may block wanted messages.

U.S. Pat. No. 6,161,130 to Horvitz, et al. teaches the iterative building of a spam-matching filter using calculated probabilities (“confidence levels”) that individual messages are spam and then determining if the user agrees. In addition to the aforesaid general limitations, its drawbacks include 1) the user's direct involvement in “teaching”, and re-teaching, the system to recognize spam messages as such, and not to identify non-spam messages as spam; 2) the user's involvement is on-going, to the extent that the content or characteristics of incoming spam messages evolves over time; and 3) relying on statistical/probabilistic filtering, which cannot block unwanted messages as rigorously as, for example, whitelists, and sometimes may block wanted messages.

U.S. Pat. No. 6,167,434 to Pang teaches the use of an icon in a client system which allows a user to auto-reply to a sender of e-mail spam to “remove” the recipient's email address from the spam-sender's e-mailing list. In addition to the aforesaid general limitations, among its drawbacks are 1) the user must individually respond to each spam message to attempt to take preventive action; 2) there is no assurance that the reply e-mail address of the spam-sender is legitimate; and 3) there is no assurance that the spam-sender will see the user's reply, let alone take the action the user desires.

U.S. Pat. No. 6,321,267 to Donaldson teaches using a filter based on multiple tests including sender address validity-checking; analysis of presumed-valid characteristics of the sender's communication such as the sender's Internet Protocol (IP) address and e-mail headers; sender's system's status as an e-mail relay; and sender's use of dial-up connectivity. It has the advantage of being highly automated, with little user involvement or management required, but, in addition to the aforesaid general limitations, it suffers from drawbacks that include 1) all the message content and characteristics to be tested can be faked by a competent spam-sender; 2) all the message content and characteristics to be tested can be made to seem legitimate by forwarding through or initiating the spam from a coopted computing or communicating device; and 3) messages which are desired by a user may be inadvertently blocked based upon how they are composed or transmitted by the sender. The aforesaid spamming technique of coopting messaging devices has become widespread; millions of infected personal computers now spread spam messages daily, unbeknownst to their owners.

U.S. Pat. No. 6,330,590 to Cotton teaches assigning a numerical code to an e-mail message, checking the code over time to identify mass mailings, and using the code to filter out further copies of a mass-mailed message. In addition to the aforesaid general limitations, it has drawbacks which include that spam-senders can easily defeat code-matching by incorporating varying content, or hidden varying content, from instance to instance of a bulk message.

U.S. Pat. No. 6,484,197 to Donohue teaches the generation, distribution to, and use by e-mail senders of authorizing tokens, with each token being valid for a limited number of occasions of access to a user's e-mail inbox. In addition to the aforesaid general limitations, it has drawbacks including 1) legitimate senders of automated e-mails such as publishers, merchants, on-line service providers, and the like, must selectively adapt their systems to make use of a user's tokens; 2) tokens may remain valid long after their period of utility, or may be used up before their period of utility is ended, requiring user intervention to administrate the appropriate issuance of replacement tokens after the number of allowed uses has been exceeded or to disable tokens; 3) tokens may become compromised if shared, legitimately or otherwise, among senders; 4) the user must invite senders to obtain tokens, as by causing the generation and distribution of tokens to desired senders; and 5) all senders, automated and otherwise, must adapt their systems and/or procedures to manage and transmit or retransmit tokens received from their recipients who are users.

U.S. Pat. No. 6,546,416 to Kirsch teaches a challenge-response approach to filtering out bulk e-mail, wherein the user's e-mail system requests a legitimizing response from an unknown sender's system, tests the response, and may then add the sender's e-mail address to a whitelist. In addition to the aforesaid general limitations, it has drawbacks including 1) legitimate senders of automated e-mails such as publishers, merchants, on-line service providers, and the like, must selectively adapt their systems (or teach their personnel) to respond to such requests; 2) senders must thereafter always send e-mail from the identical sending address to assure messages are accepted by the user; 3) senders whose legitimate receiving address does not match their legitimate sending address may never receive the user's request; and 4) all senders, automated and otherwise, must adapt their systems and/or procedures to receive and respond to requests received from their recipients who are users.

U.S. Pat. No. 5,619,648 to Canale, et al. teaches adding keyword-like information to an e-mail message to allow filtering or routing it based on the predetermined interests of the user, and optionally of the user's e-mail correspondents. In addition to the aforesaid general limitations, it has drawbacks including 1) legitimate senders of automated e-mails such as publishers, merchants, on-line service providers, and the like, must selectively adapt their systems to include such information in their outgoing e-mail messages; 2) users must identify and manage profiles of their interests; and 3) senders of spam e-mails may easily include keyword-like information in their messages to assure that the user's e-mail system, and possibly those of the user's e-mail correspondents, are fooled into accepting and possibly forwarding the spam e-mail messages.

U.S. Pat. No. 5,999,932 to Paul teaches flagging incoming messages with codes to affect how the message is displayed on a user terminal, based on whether field values in the e-mail can be matched to a stored list and whether the e-mail content is otherwise “of interest” to the user. In addition to the aforesaid general limitations, it has drawbacks including 1) on-going user management of the stored list of e-mail field values to be matched against; 2) on-going user communication to desired senders to inform them of what e-mail field values to use, where required; and 3) legitimate senders of automated e-mails such as publishers, merchants, on-line service providers, and the like, may need to adapt their systems to include certain e-mail field values in their outgoing e-mail messages to assure the desired display on the user terminal.

U.S. Pat. No. 5,999,967 to Sundsted teaches the use of e-mail stamps having a financial value. In addition to the aforesaid general limitations, its drawbacks include 1) all senders must adapt their systems and/or procedures to obtain, pay for, and incorporate e-mail stamps for use with e-mails sent to users requiring stamps; 2) users and senders must evaluate and agree on (directly or indirectly) the stamp prices each is willing to accept; and 3) a market or market mechanism for issuing, billing for, accounting for, and collecting and distributing funds related to e-mail stamps must be created and operated.

U.S. Pat. No. 6,023,723 to McCormick, et al. teaches e-mail filtering using an e-mail-address-based whitelist and blacklist, wherein messages from a sender on neither list are quarantined until the user decides to add the sender to either list. This has the advantage of requiring no changes to the systems or processes of senders. But it suffers from the aforesaid general limitations, including a requirement for on-going user management of the whitelist and blacklist and categorizing of senders who are on neither list. This is a particular chore for the user regarding senders, such as on-line merchants, whose messages are desired for a period of time, and then are no longer desired.

U.S. Pat. No. 6,199,103 to Sakaguchi, et al. teaches determining whether an e-mail message is “junk” through a junk-testing comparison followed by a textual analysis of the message contents. In addition to the aforesaid general limitations, it suffers from drawbacks that include 1) the message content and characteristics to be tested can be manipulated by a competent spam-sender; 2) messages which are desired by a user may be inadvertently blocked based upon how they are composed or transmitted by the sender; and 3) textual analysis is inherently probabilistic and therefore will not block unwanted messages as rigorously as, for example, whitelists, and sometimes may block wanted messages.

U.S. Pat. No. 6,249,805 to Fleming III teaches filtering of incoming e-mail messages according to a whitelist of authorized senders and exception-handling of unauthorized senders by forwarding messages from unauthorized senders for approval of the sender (or of the message) by a third party. It has the advantages of using a whitelist, but it suffers from the aforesaid drawbacks related to whitelists, as well as added procedural complexity and delay introduced by third-party approval of senders.

U.S. Pat. No. 6,393,465 to Leeds teaches a challenge-response approach to filtering out e-mail having a fraudulent sender address, wherein the user's e-mail system requests a legitimizing response from an unknown sender's host system. In addition to the aforesaid general limitations, it has drawbacks including 1) legitimate senders whose host systems are not configured to respond as required to such requests will be determined to be illegitimate; 2) senders must always send e-mail from a host-server-verifiable sending address to assure messages are accepted by the user, even when there are legitimate reasons to supply an alternate sending address; and 3) a competent spam-sender may nevertheless seem legitimate by forwarding through or initiating the spam from a coopted computing or communicating device.

U.S. Pat. No. 6,421,709 to McCormick, et al. teaches blocking incoming e-mail messages that match examples of spam e-mail messages in a server, and allowing a user to add a received e-mail message to the list of stored examples of spam e-mail messages. It suffers from the aforesaid limitations generally applicable to content-based spam-prevention techniques.

U.S. Pat. No. 6,453,327 to Nielsen teaches updating a network's spam e-mail filters and blocking a mass-distributed spam e-mail message based on message-categorizing responses received centrally from individual network users in regard to the message. In addition to the aforesaid general limitations, it suffers from drawbacks that include requiring at least some users to take action to update the network's filters for each received spam e-mail message.

U.S. Pat. No. 6,112,227 to Heiner teaches a challenge-response approach to authorizing an unknown sender via a registration process that is initiated by the user's e-mail system. In addition to the aforesaid general limitations, it has drawbacks including 1) legitimate senders of automated e-mails such as publishers, merchants, on-line service providers, and the like, must selectively adapt their systems (or teach their personnel) to respond to such requests; 2) senders must thereafter always send e-mail from the identical sending address to assure messages are accepted by the user; 3) senders whose legitimate receiving address does not match their legitimate sending address may never receive the user's request; 4) all senders, automated and otherwise, must adapt their systems and/or procedures to receive and respond to requests received from their recipients who are users.

These and other drawbacks exist with current systems and methods.

### BRIEF SUMMARY OF THE INVENTION

Accordingly, various embodiments of the present invention may be directed to a system and a method for controlling whether and/or how electronic messages transmitted to one or more recipients are received, in which the user may directly or indirectly establish a plurality of permissions for senders of electronic messages to communicate to the one or more recipients, and in particular, in which the permissions may, in whole or in part, be limited to a plurality of predetermined durations, and in which specific limited-duration permissions may be granted and revoked automatically (that is, with minimal or no user intervention).

According to an exemplary embodiment of the present invention, certain electronic messages, based on a plurality of predetermined criteria which may be user-defined, are treated differently from other messages upon and/or following their arrival.

A plurality of user profiles, each comprised of at least one criterion to be considered in determining whether and/or how a given message should be treated, categorized, or processed, may be considered upon the arrival of one or more messages. The at least one criterion may also comprise at least one computer-implemented method and any associated parameters, as may be taught in the related art, such as whitelist and blacklist matching, statistical content analysis, challenge-response tests, aggregated user feedback, string matching and field matching, other content-based filtering, and others. The at least one criterion and/or at least one associated parameter thereof may include, or be otherwise associated with, date and/or time information indicative of when the at least one criterion and/or the at least one associated parameter begins and/or ceases to apply. Such associated date and/or time information may be comprised of one or more of relative expiration dates, absolute expiration dates, relative commencement dates, absolute commencement dates, date ranges, duration values, and other date- and time-based information The at least one criterion may also be used in combination with at least one other criterion which may be date- and/or time-limited, and/or which may have date- and/or time-related parameters.

As will be apparent to those skilled in the art, a variety of combinations of criteria, which may have associated parameters that may include associated date and/or time information, may be considered in series, in parallel, or in other arrangements, in regard to one or more arriving messages.

The criteria may be grouped or otherwise organized into user profiles, and the criteria and/or profiles may be user-defined.

When one or more messages arrives, each message may be modified to facilitate the consideration and/or application of relevant criteria. For example, the relevant criteria may include that a predetermined non-expired authorization code be present in a particular location within the contents of, data field(s) of, or header(s) of the message; in particular, if the code is required to be embedded in or concatenated with the recipient-address portion of the message, that portion of the message may require subsequent modification in order that the message may reach its intended recipient successfully.

Additionally or alternatively, the relevant criteria may include that aliased data be used by the sender in place of “true” data in one or more fields, headers, or other portions of the message. For example, a sender might be provided such aliased information to use in communicating with a potential recipient to protect the privacy of the recipient by not disclosing “true” data to any non-trusted senders or potential senders. An alias e-mail address, for example, may be used in place of a true e-mail address. However, when aliased data are used, it may then become necessary to substitute the corresponding “true” data for the aliased data in the message, or add in the “true” data, to enable the message ultimately to reach, and be properly processed, treated and/or understood by, the end-recipient or -recipients.

According to an exemplary embodiment of the present invention, criteria may be defined at multiple levels of specificity, ranging from a macro level, at which criteria may, for example, be applicable to all messages of all types from all sources at all times; to highly granular, micro levels, which may be applicable specifically, for example, to e-mails having certain predetermined content, from a specific sender, containing certain header fields and corresponding data values, and arriving prior to a certain date. Preferably, the higher level criteria may be superseded by lower level criteria, in such cases where the same message meets both higher level and lower level criteria.

According to an exemplary embodiment of the present invention, a plurality of criteria may also be defined in partially or fully abstracted or otherwise generalized terms (hereinafter, “Template Criteria”), and then take effect as individual, specific instances (hereinafter, “Specific Criteria”) once one or more messages arrives fitting the Template Criteria (hereinafter, “Triggering Messages”). Thereafter, the Specific Criteria may supersede the Template Criteria regarding any messages where both would apply. (Criteria which do not spawn other criteria based on message arrivals are hereinafter termed “Self-Contained Criteria.”)

In a user profile, additionally or alternatively to a plurality of Self-Contained Criteria, the user may define a plurality of Template Criteria and the scope of any Specific Criterion or Criteria which may be spawned based on the plurality of Template Criteria. These Specific Criteria may be auto-generated or pre-generated. An auto-generated Specific Criterion is a criterion which is defined, and whose parameter or parameters if any are defined, by data contained within or accompanying the criterion's Triggering Message. For example, if a Template Criterion specifies a sender's Internet domain name as a parameter of a resulting Specific Criterion, then the Specific Criterion may have as a parameter the specific sender's Internet domain name found in the Triggering Message. Such parameter(s) may also be modified prior to being incorporated in a Specific Criterion.

According to another example, a Template Criterion may define the recipient's aliased address, and/or an authorization code to be found therein or elsewhere in the message, as a parameter for a corresponding Specific Criterion. In this manner, the user can create aliases and/or authorization codes ad hoc, independently of the inventive system, merely by providing them as or within e-mail or other messaging addresses provided to potential message senders in the routine course of events (such as to e-commerce web sites when placing orders there). When incoming messages containing such aliases and/or codes later arrive, the messages may thereby auto-generate Specific Criteria and/or associated parameters germane to those senders. Each such Specific Criterion and/or parameter may have or include its own associated date- or time-limitation as well. Thus, absent further user intervention, senders who use aliases and/or authorization codes created by the user outside an embodiment of the inventive system can automatically be authorized and preferably date- and/or time-limited in when and/or how long their messages will be accepted by the embodiment of the inventive system, and other senders who obtain the same aliases and/or authorization codes may be automatically blocked from acceptance of any of their messages by the embodiment of the inventive system. In this manner, user addresses and/or authorization information may automatically take on a limited life and may be restricted to only those senders with whom they were initially shared, all without requiring any explicit user actions to identify and administer individual addresses and/or individual authorization information. Many other arrangements and variants of the distribution and/or the date- and/or time-limitation of aliases and/or authorization codes, and/or other criteria and parameters, will be apparent to those skilled in the art.

Pre-generated Specific Criteria are those which are defined by the user prior to, or in addition to, auto-generated Specific Criteria.

According to an exemplary embodiment of the present invention, one or more actions may be associated with one or more criteria; when one or more criteria is met by a given message, the one or more associated actions may then be taken. Among such actions may be rejecting a message, modifying a message, transmitting a message to a plurality of associated recipients, forwarding a message, notifying a plurality of recipients about the message and/or about actions taken regarding the message, accepting a message, quarantining a message, filing/storing/archiving a message, copying a message, discarding a message, sending an automated reply message, identifying the message distinctly to the user and/or its recipient(s), logging the message and/or information about the message, generating one or more alarms, and a variety of other actions.

According to an exemplary embodiment of the present invention, one or more default actions may be defined that are applicable to all messages, or to messages belonging to a plurality of categories such as the type or format or medium of the messages, in the event that any message does not meet any specific criteria. For example, a default action associated with such messages may be simply to discard them.

An exemplary embodiment of a system according to the present invention may be configured in a number of ways, including as a client system or software, which may cooperate with or act in series with client messaging software, such as client e-mail software; as a server-based system or software, which may act cooperatively or in conjunction with a client system or software, or with web documents or web applets in a web browser, which interactions may occur over a communications link or network; as one or more web services executing on or among one or more web-based systems; and, as a data processing service which cooperates with or acts in series with one or more of client systems or software and server-based systems or software, typically over a communications link or network. As will be apparent to those skilled in the art, a system according to the present invention can also be implemented in a variety of other configurations of hardware, software, and communication networks, which may include telephony networks and devices, mobile data messaging networks and devices, distributed application and database servers, distributed and grid computing networks, web services, and others, in a variety of topographies and underlying technologies.

Via a user interface, the user may establish and/or modify a plurality of profiles which may define or help define which incoming messages should be accepted and which rejected, or, alternatively or additionally, how individual incoming messages should be sorted or categorized such that a plurality of subsequent actions may be taken by the inventive system, or by an external system, such as by an e-mail server or other messaging-related system.

It is to be understood that both the foregoing general description and the following detailed description are exemplary and explanatory only and are not restrictive of the invention, as claimed.

### BRIEF DESCRIPTIONS OF THE DRAWINGS

FIGS. 1a-c are block diagrams illustrating, respectivly, client-based, server-based, and service-based embodiments of the present invention.

FIG. 2 is a flowchart of an exemplary routine that implements controlled message receipt in accordance with the invention.

FIG. 2a is a flowchart of a second exemplary routine that implements controlled message receipt in accordance with the invention.

FIG. 2b is a flowchart of an exemplary routine that implements controlled message receipt in accordance with the invention, wherein supplementary acceptance tests for a message may be performed in series.

FIG. 2c is a flowchart of an exemplary routine that implements controlled message receipt in accordance with the invention, wherein supplementary acceptance tests for a message may be performed in parallel.

FIG. 2d is a flowchart of an exemplary routine that implements controlled message receipt in accordance with the invention, wherein a message which meets one or more general, or “template”, criteria, spawns one or more instance-dependent, or “specific”, criteria which may supersede the one of more general criteria for a period of time, or indefinitely.

FIG. 3 is a flowchart of an exemplary routine that implements controlled message receipt in accordance with the invention, wherein whitelist processing is performed.

FIG. 4 is a flowchart of an exemplary routine that implements controlled message receipt in accordance with the invention, wherein whitelist and blacklist processing are performed.

FIG. 5 is a flowchart of an exemplary routine that implements controlled message receipt in accordance with the invention, wherein authorization information is included and/or sought as part of the recipient's address associated with a message.

FIG. 6 is a flowchart of an exemplary routine that implements controlled message receipt in accordance with the invention, wherein the recipient's address, which may be an alias address, associated with a message is considered in accepting the message, and if an alias, may be substituted with one or more substitute addresses, one or more of which may the recipient's true address.

FIGS. 7a-7c illustrate controlled message receipt and aspects of a user interface in an exemplary embodiment of the present invention.

### DETAILED DESCRIPTION OF THE INVENTION

The present invention provides a method and system for controlling receipt of a plurality of electronic messages, and in particular, for selectively accepting and/or processing a plurality of incoming messages based upon a plurality of acceptance and/or processing criteria, at least one of which acceptance and/or processing criteria may expire after a predetermined duration and/or as of a predetermined date and/or time. The present invention further provides a method and system for automatically associating one or more of acceptance and/or processing criteria and/or related parameters, which criteria and/or parameters may include or have associated date- and/or time-limitations, with any attribute, of an incoming message, such as the sender's identity, without the user needing to define specific permissions, criteria, and/or parameters for each case, or for any case.

According to an exemplary embodiment of present invention, one or more criteria may be defined for use with a plurality of incoming electronic messages upon, or following, their arrival. The one or more criteria may be used individually, in various combinations, and in conjunction with various other tests, to determine whether and/or how a message is to be received and, preferably, subsequently processed.

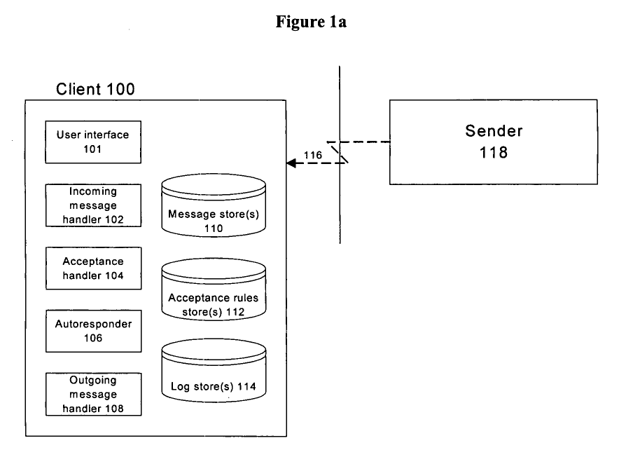

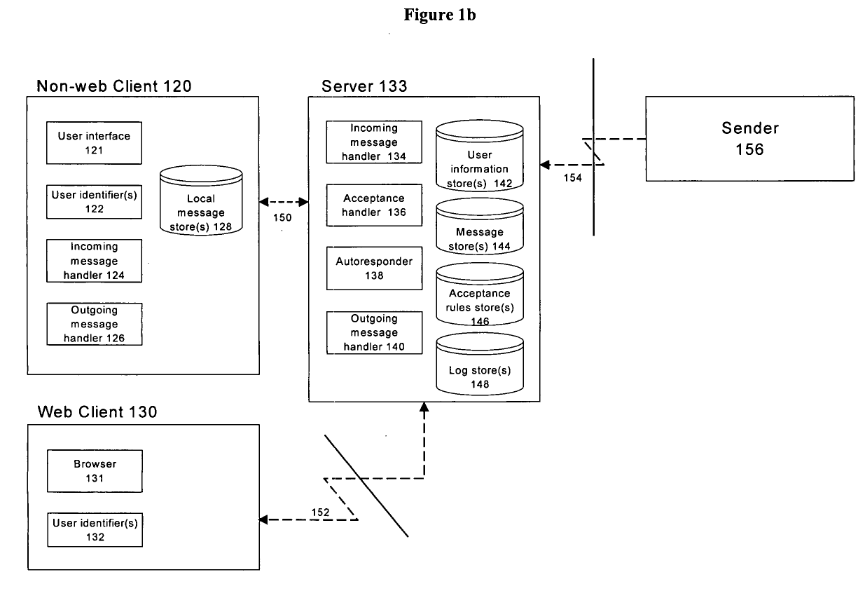

A variety of configurations of exemplary systems in accordance with the present invention is possible, three of which are shown in FIGS. 1a-c. According to one example, as shown in FIG. 1a, a client system or device 100 may receive one or more messages from a sender 118, possible via a communications link or network 116. In this example, the client 100 may be comprised of
a user interface 101 for one or more of adding, modifying, viewing, reporting on, and deleting the one or more criteria, preferably one or more associated parameters, and preferably one or more associated actions; and for performing other tasks related to administering and using the exemplary system;
an incoming message handler 102 which may take in a plurality of incoming messages and may store them temporarily or permanently in one or more message stores 110;
an acceptance handler 104 which may apply, create, modify, report on, and delete the one or more criteria and/or one or more associated parameters on a scheduled, ad hoc, or event-driven basis, or as directed by the user through the user interface 101; and which may store temporarily or permanently the one or more criteria and/or one or more associated parameters and/or one or more associated actions in one or more acceptance rules stores 112; and which may apply the one or more criteria, with consideration of any associated parameters if they exist, to the plurality of incoming messages, and may then initiate or take one or more of the one or more associated actions, if they exist, which may include modifying one or more of the plurality of incoming messages;
one or more log stores 114, where information may be recorded by the client 100 and/or any and/or all of its elements about one or more of messages, criteria, parameters, actions, and internal states of and steps taken by the client 100; and which may be used to generate informational displays, notifications, and reports;
an autoresponder 106 which may generate outgoing messages to a plurality of senders, or a plurality of third parties, or both, in response to the arrival of one or more incoming message, or in response to the initiation of an auto-response action by another component of the client 100, such as the acceptance handler 104; and
an outgoing message handler 108 which may generate and/or transmit messages to a plurality of recipients, which may include a plurality of senders; a plurality of such messages may from time to time include messages that provide information usable by senders to meet message acceptance criteria that may be imposed at certain times, or at all times, by an embodiment of the inventive system.

The client 100 may be integrated or co-installed with messaging client software or hardware, such as an e-mail software application program, in which case some functionality ascribed to the client, such as the outgoing message handles 108 and message store(s) 110, may exist in or be managed by the e-mail software application program in addition to, or alternatively to, the client 100.

Each component of the client 100 may exist as a subcomponent of another component; for example, the acceptance handler 104 may be a subcomponent of the incoming message handler 102, and the autoresponder 106 a subcomponent of the outgoing message handler 108. Each component may also exist separate from the client 100, provided such a separated component remains able to interact remotely with the client 100.

The one or more acceptance rules stores 112 may include stored information representing whitelists, blacklists, and other contextual information which may act as criteria and/or parameters for use by the acceptance handler 104 and by any other modules or functional elements of the client 100.

The various information stores 110, 112, 114 may exist in the form of one or more memories, one or more databases, one or more data files, or other forms, or in combinations thereof. They may also be integrated with, subsumed within, built upon or in, or replaced by external information stores, such as contact folders or databases, customer-relationship-management and supply-chain-management databases, address books, buddy lists, other databases, and other types of information stores.

The client 100 may exist separately for each user, logically or physically, or it may be shared, logically or physically, by multiple users. In the case of multiple users, the client 100 may also be comprised of a module and/or one or more associated information stores which enable the client 100 to distinguish among and permit managed and controlled access by the multiple users, either concurrently or serially.

FIG. 1b shows an alternative embodiment of a system in accordance with the present invention, in which one or more of the functional elements of the client 100 as described above, in particular an incoming message handler 134, acceptance handler 136, autoresponder 138, outgoing message handler 140, one or more message stores 144, one or more acceptance rules stores 146, and one or more log stores 148, may reside in, or otherwise be managed by, a server 133. The server 133 may interact with a non-web client system or device 120, which may be similar to that described in FIG. 1a (viz., an exemplary client 100), or a web client 130. The server 133 may also function autonomously, that is, with no client. Incoming messages from a plurality of senders 156 arrive at the server 133.

The server 133 may additionally be comprised of one or more user information stores 142 which may contain information about each of a plurality of users. The one or more user information stores 142 may be accessed and/or updated by any or all of the handlers 134, 136, 138, 140, and may also be used to manage interactions between the server 133 and a plurality of non-web clients 120 and web clients 130.

Each component of the server 133 may exist as a subcomponent of another component; for example, the acceptance handler 136 may be a subcomponent of the incoming message handler 134, and the autoresponder 138 a subcomponent of the outgoing message handler 140. Each component may also exist separate from the server 133, provided such a separated component remains able to interact remotely with the server 133.

The one or more acceptance rules stores 146 may include stored information representing whitelists, blacklists, and other contextual information which may act as criteria and/or parameters for use by the acceptance handler 136 and by any other modules or functional elements of the server 133.

The various information stores 142, 144, 146, 148 may exist in the form of one or more memories, one or more databases, one or more data files, or other forms, or in combinations thereof. The information stores may also be integrated with, subsumed within, built upon or in, or replaced by external information stores, such as contact folders or databases, customer-relationship-management and supply-chain-management databases, address books, buddy lists, other databases, and other types of information stores.

Two exemplary client configurations are shown in FIG. 1b, one a non-web client 120, which may be similar to the messaging client shown in FIG. 1a, the other a web client 130, which may be comprised of a web browser 131 in which web pages and/or web applets may be displayed and/or execute so as to provide user interface functionality for and access to the server 133, typically via a communications link or network 152, and one or more user identifiers 132 which serve to distinguish and/or authenticate individual non-web clients 120 and/or their users to the server 133.

The non-web client 120 may be comprised of a user interface 121, one or more user identifiers 122 which serve to distinguish and/or authenticate individual non-web clients 120 and/or their users to the server 133. The non-web client 120 may be logically or physically integrated with the server 133, may communicate with the server 133 through a direct local connection, or may communicate with the server 133 over a communication link or network 150. The server 133 may transfer to or replicate messages with a non-web client 120, preferably following acceptance handling that the server 133 may perform, in which case the non-web client 120 may store such messages temporarily or permanently in one or more local message stores 128. The server 133 may temporarily or permanently store messages that pass through it or are generated by it in its own one or more message stores 144.

The server 133 as shown in FIG. 1b appears as a single logical unit, but it may also exist as multiple separate logical and/or physical units and/or as multiple servers acting in concert or independently, each of which servers may be comprised of multiple separate logical and/or physical units.

Other configuration variations will be apparent to one skilled in the art.

FIG. 1c shows an exemplary embodiment of a system according to the present invention configured as a data processing service, that is, as an intermediary server 162 which interacts with a plurality of receiving servers or clients 160. This exemplary configuration may preprocess a plurality of messages received from a plurality of senders 184, and may transmit accepted or other messages and/or related information to the plurality of receiving servers or clients 160.

In the exemplary embodiment of FIG. 1c, one or more of the functional elements of the server 133 as described above, in particular an incoming message handler 166, acceptance handler 168, autoresponder 170, outgoing message handler 172, one or more message stores 174, one or more acceptance rules stores 176, and one or more log stores 178, may reside in, or otherwise be managed by, an intermediary server 162. The intermediary server 162 may interact with a receiving server or client 160, which may be similar to the clients and server described in FIGS. 1a and 1b. This interaction may occur over a communications link or network 180. The intermediary server 162 may also function autonomously, that is, with no interactions with external servers or clients. A Incoming messages from a plurality of senders 184 may arrive at the intermediary server, and may arrive over a communications link or network 182.

The intermediary server 162 may additionally be comprised of one or more user information stores 173 which may contain information about each of a plurality of users. The one or more user information stores 173 may be accessed and/or updated by any or all of the handlers 166, 168, 170, 172, and/or via the user interface 164, and may also be used to manage interactions between the intermediary server 162 and a plurality receiving servers or clients 160.

Each component of the intermediary server 162 may exist as a subcomponent of another component; for example, the acceptance handler 168 may be a subcomponent of the incoming message handler 166, and the autoresponder 170 a subcomponent of the outgoing message handler 172. Each component may also exist separate from the intermediary server 162, provided such a separated component remains able to interact remotely with the intermediary server 172.

The one or more acceptance rules stores 176 may include stored information representing whitelists, blacklists, and other contextual information which may act as criteria and/or parameters for use by the acceptance handler 168 and by any other modules or functional elements of the intermediary server 162.

The various information stores 173, 174, 176, 178 may exist in the form of one or more memories, one or more databases, one or more data files, or other forms, or in combinations thereof. The information stores may also be integrated with, subsumed within, built upon or in, or replaced by external information stores, such as contact folders or databases, customer-relationship-management and supply-chain-management databases, address books, buddy lists, other databases, and other types of information stores.

The receiving server or client 160 may be logically or physically integrated with the intermediary server 162, may communicate with the intermediary server 162 through a direct local connection, or may communicate with the intermediary server 162 over a communication link or network 180. The intermediary server 162 may transfer to or replicate messages with a receiving server or client 160, preferably following acceptance handling that the intermediary server 162 may perform, in which case the receiving server or client 160 may store such messages temporarily or permanently in its own one or more local message stores, they exist. The intermediary server 162 may temporarily or permanently store messages that pass through it or are generated by it in its own one or more message stores 174.

The intermediary server 174 as shown in FIG. 1c appears as a single logical unit, but it may also exist as multiple separate logical and/or physical units and/or as multiple servers acting in concert or independently, each of which servers may be comprised of multiple separate logical and/or physical units.

Other configuration variations will be apparent to one skilled in the art.

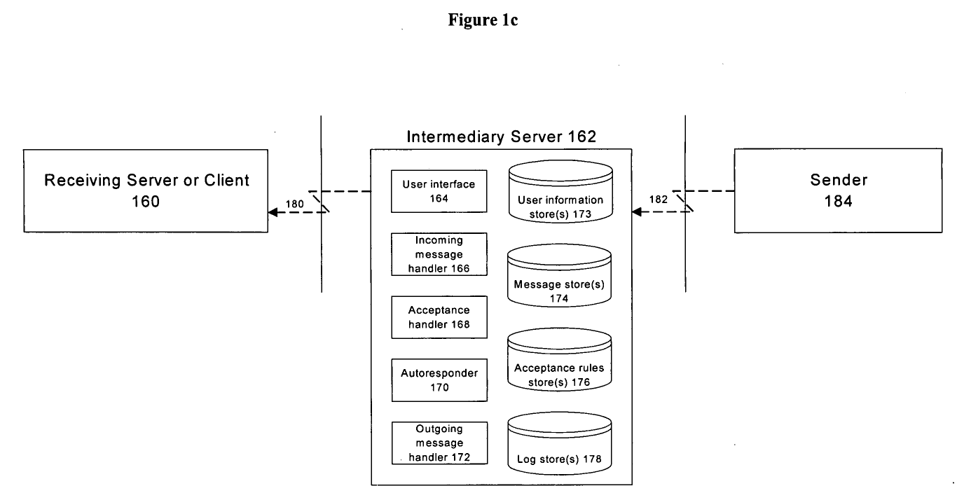

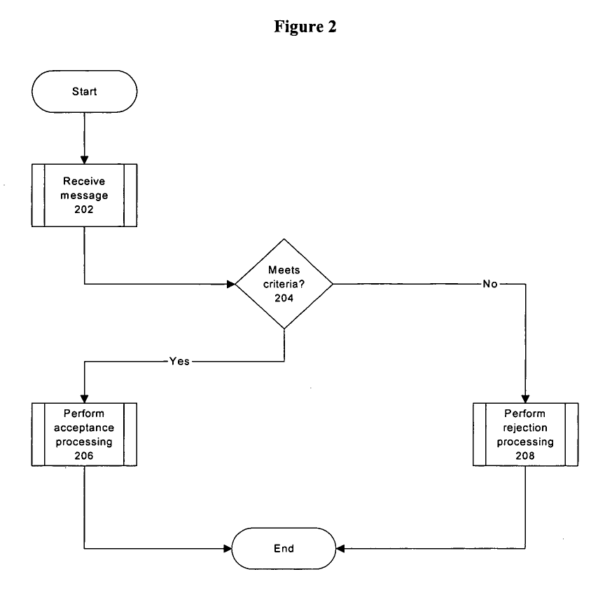

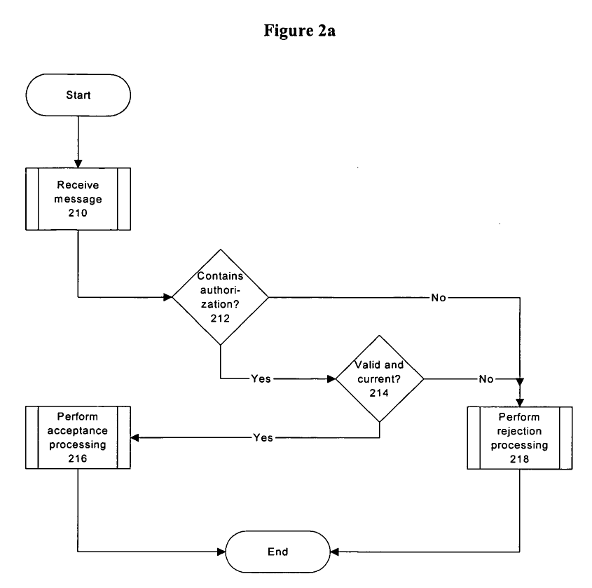

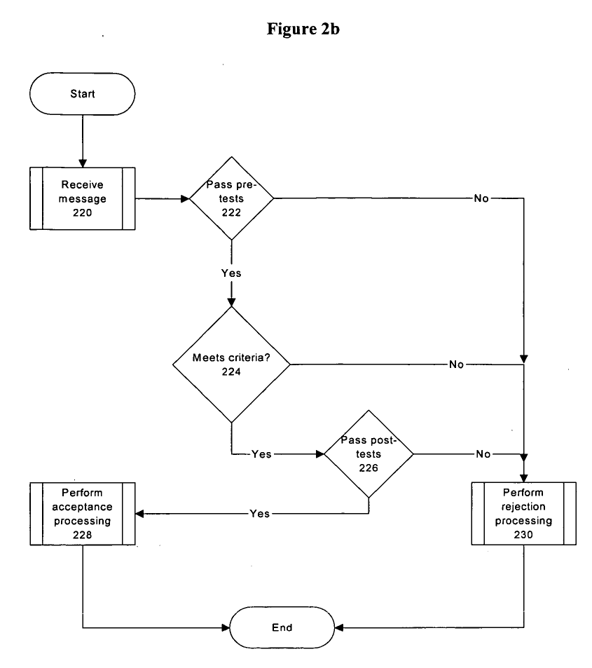

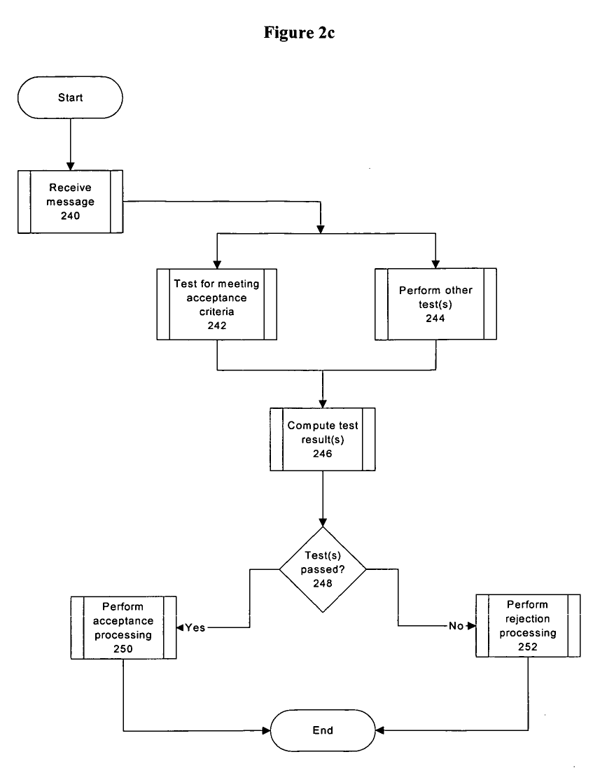

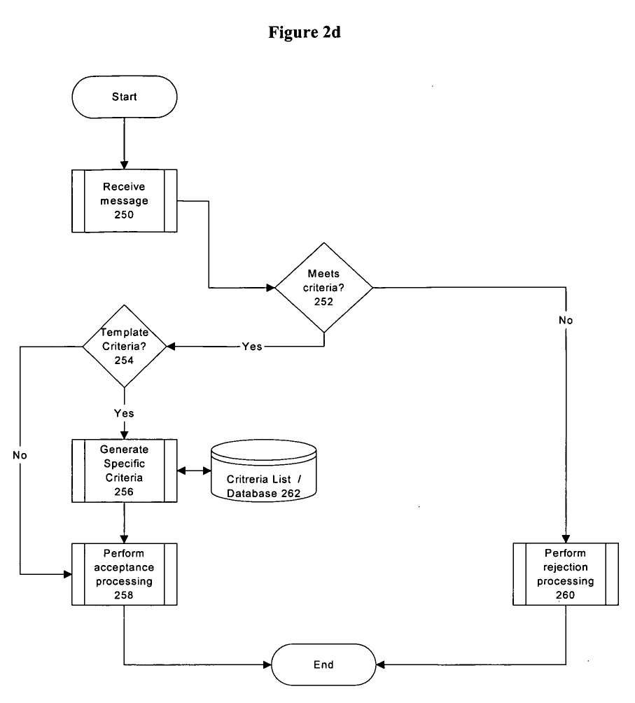

FIG. 2 describes the general process flow of an exemplary embodiment of the present invention. When a message arrives (receive message block, 202) for one or more intended recipients, one or more applicable criteria are considered in regard to the message. Said criteria may be predetermined and have been stored in a user profile, and may be user defined. Each criterion may also have associated one or more parameters as context for, or to be considered in, the application of the criterion.

If the one or more criteria are met 204, acceptance processing 206 occurs in regard to the message. Conversely, if the message does not meet the applicable criteria, rejection processing 208 occurs.

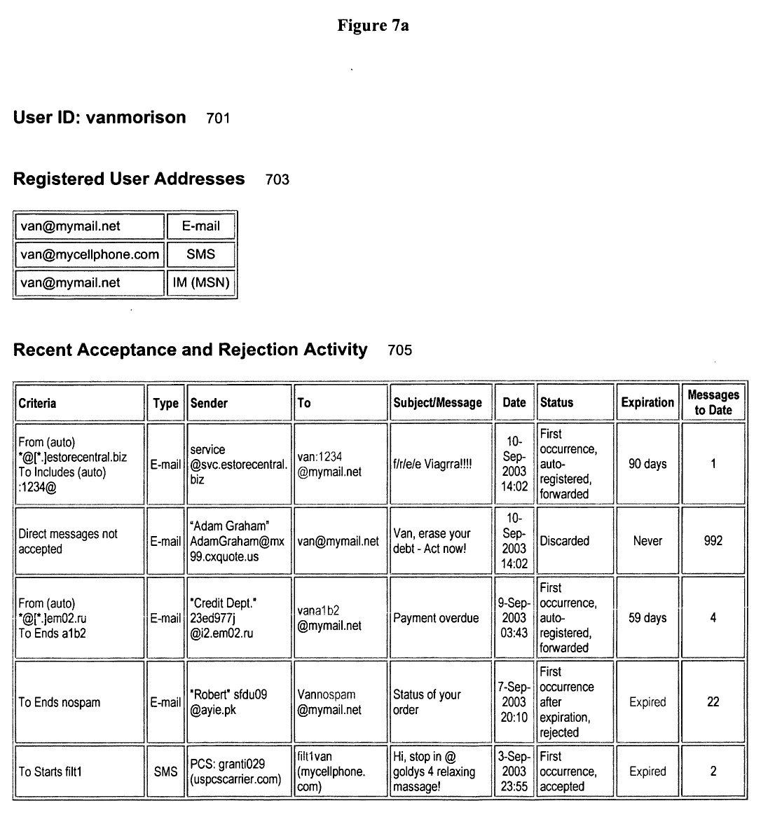

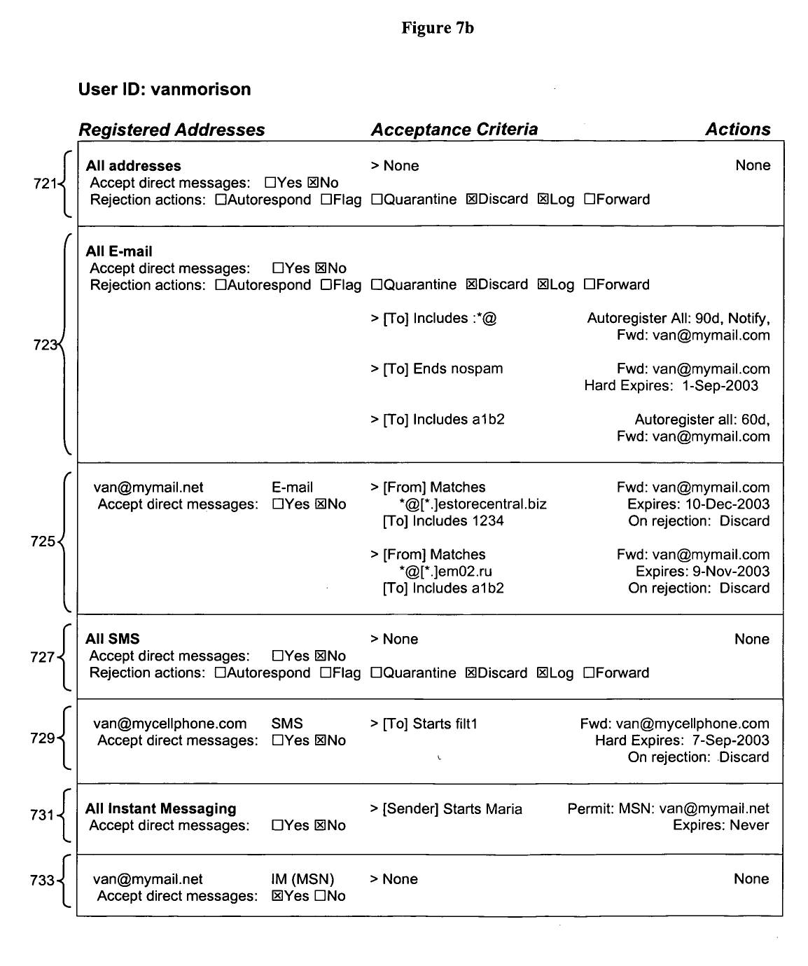

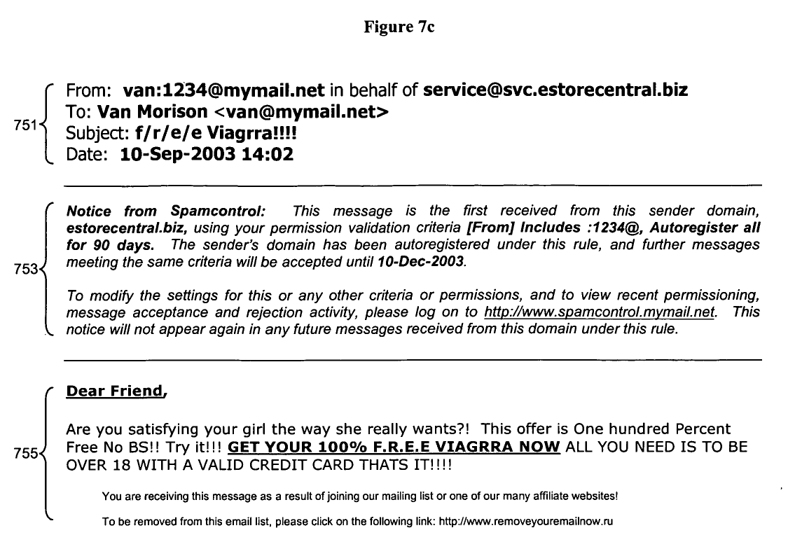

If more than one criterion applies to a given message, criteria may be applied in series or in parallel, or in other combinations, as described more fully below (see also FIGS. 2b, 2c). Criteria may also be applied in serial, parallel, and mixed serial-parallel combinations, such as by using Boolean or other logical algorithms to weigh and/or combine each criterion, and/or to assign certain criteria “veto rights” or “override rights” over other relevant criteria. Criteria may further have associated priorities or precedences, which may be based upon their level of specificity or generality, or their age or remaining lifetime, or their ordering in a tree-branch structure or other node-oriented hierarchy, or other rules, which rules may be user-defined. FIG. 7b shows an exemplary user interface view of an exemplary tree-branch structured hierarchy in accordance with the present invention.

Acceptance processing 206 and rejection processing 208 may be comprised of one or more actions, some or all of which actions may be associated with the one or more criteria, or no actions. Examples of such actions are: modifying the message, transmitting the message to a plurality of associated recipients, forwarding the message, notifying a plurality of recipients about the message and/or about actions taken regarding the message, accepting the message, quarantining the message, filing/storing/archiving the message, copying the message, discarding the message, sending an automated reply message whose contents may be predetermined or dynamically determined, identifying the message distinctly to one or more users and/or recipients, logging the message and/or information about the message, generating one or more alarms, and a variety of other actions. The order of such actions may be predefined, or computed based on criteria information, associated parameter information, the nature of the actions, predetermined action priorities and/or precedences, and/or information about or derived from the message and/or from the applicable user profile(s).

In a given embodiment, and for a given message in the given embodiment, the actions (or absence of actions) represented by the acceptance processing block 206 and rejection processing block 208 may be the same, partially the same and partially different, or completely different.

A criterion may be defined in regard to any individual aspects or element of a message, or to combinations thereof. Such aspects and elements may include
the sender's identity;
a predetermined whitelist (a list of one or more preapproved senders or sender groups; a sender group may be represented by an Internet domain name, for example) and/or a blacklist (a list of one or more pre-denied senders, sender groups, and/or routes taken by or relays passed through by a message);
the values of one or more fields associated with the message, such as the message subject, body, date/time, the presence of attachments, attachment names and/or types if any, priority or importance information, message thread information, other standard headers, user-defined headers such as (in the case of e-mail) X-headers;
the recipient or recipients' identities;
messaging session information, and
other aspects and elements.

Such aspects and elements may also include procedurally or computationally derived data, which may include the results of statistical analysis of message content, with or without consideration of a context of other similar messages heretofore received; the results of challenge-response tests; the results of aggregated user feedback, and other processes and algorithms.

A criterion or set of criteria may also be associated with one or more comparative tests to be performed, as exemplified in the meets criteria decision block 204. Such tests may be performed with, and/or in consideration of, parameters which may be associated with the criterion or the set of criteria.

Such tests may include arithmetic, Boolean, or character string logical operators, such as greater than, less than, equal to, exactly equal to, not equal to, AND, OR, XOR, NOT, implies, does not imply, and others. Such tests may also include string comparisons, such as contains, does not contain, matches, does not match. Such comparisons may use wildcards, for example, matching an e-mail Reply-To field to the wildcard “*@HometownCPA.biz”, where “*” is a wildcard character. It will be apparent to one skilled in the art that a wide variety of wildcard matching, character matching, substitution matching, and the like, all in current practice in the field of computer software, may be used to make such comparisons.

Character-string-based comparisons may also be positionally relative (for example, the character string stored in the From field ends with “CPA.com”) or positionally absolute (for example, the first four characters in the recipient's address as stored in the To field must match “1a2b”), or a combination (for example, the four characters staring at the 6th character left of the “@” in the recipient's address must as stored in the To field must match “1a?b”, where “?” is a wildcard character). Matching may also per performed against a predetermined list of possible matches, such as a whitelist or blacklist of approved or disallowed senders, respectively.

An element of the present invention which creates high utility is the use of criteria which are comprised of, or are otherwise associated with, date- and/or time-related information, whereby the date- and/or time-related information serves to limit when the associated acceptance criterion or criteria apply. (Date and time information may also be used in the reverse, to describe when one or more associated criteria should not apply.)

Such date and/or time information may include one or more of relative expiration dates, absolute expiration dates, relative commencement dates, absolute commencement dates, date ranges, duration values, and other date- and time-based information. Date- and time-based information may in general be absolute or relative, continuous or discrete, specific or wildcarded. For example, a wildcarded date range as part of a criterion may be defined as a sender's domain matching “flowershopping.com” only during May (“5/*/*”), thereby causing solicitation messages from the associated commercial entity to be accepted only during May, for example, to facilitate a Mother's Day flower purchase.

Criteria, associated parameters, and associated actions may be user-defined and/or user-selected, and may be organized into user profiles, which may also be used-defined.

FIG. 2a shows an exemplary flow regarding message acceptance in accordance with the present invention, wherein an exemplary criterion has been defined comprising an authorization code to be located within or accompanying the message, which authorization code having to be valid and current (for example, non-expired) for the message to be accepted.

An application of the present invention with high utility is enabling an authorization mechanism that allows one or more permissioned senders to provide, directly or indirectly, an authorization value as a message acceptance criterion. The authorization value, if present in an incoming message, is checked against at least one parameter associated with the message acceptance criterion. The criterion and the at least one parameter may be stored in a user profile, which may be user defined.

The authorization value may be required to be supplied anywhere in or along with the message, but more usefully, either as or embedded in a specific field, such as, in an e-mail example, the Subject field or the To field, or in the form of an extention to or alias of the recipient's address.

In accordance with the example shown in FIG. 2a, after a message is received 210, it is examined for the presence of the appropriate authorization field and/or value 212, which may be a character-string value (such as a password or authenticating token), a digital signature, or another type of value or data. If the authorization field/value is identified, it may then be tested in regard to whether it is both valid (that is it meets the tests specified in the form of the associated message acceptance criterion or criteria) and current. By current, it is meant that the associated plurality of criteria and/or the associated plurality of parameters is time- or date-limited, as described earlier.

If the authorization criteria are met, acceptance processing 216 may then occur, as described previously; if not, rejection processing 218, as described previously.

If predefined, the authorization value may be communicated to the sender by the user, or by the inventive system. In the former case, the user may enter the authorization value into an appropriate acceptance rules store (FIG. 1a: 112, 1b: 146, 1c: 176) before or after the fact. In the latter case, it may be stored automatically in an acceptance rules store (FIG. 1a: 112, 1b: 146, 1c: 176), or an accessible address book, buddy list, contacts folder, database, or other store or memory, and distributed automatically by the inventive system or by the inventive system under the user's control. It may also be other includes viral, part of message(s). The authorization value may also be generated by the inventive system. The inventive system may also provide the user with an analysis of the relative “guessability” of an authorization value chosen by the user.

The authorization value may be of an arbitrary of fixed length; of arbitrary characteristics such as case sensitivity and the inclusion of numerical digits, etc.

In an exemplary embodiment of the present invention, the number of authorization codes which may exist and/or be current at any one time may be limited in a variety of ways, including limitations per user, per each group or list of common message attributes (such as a group or list of senders), all messages for a given user, all messages for all users, and other arrangements.

A variety of placements are possible for the authorization value, which may include placement in body of a message, either at a certain absolute or relative position, at no specific position, or delimited by other predetermined character strings; placement in an attachment of a specified type if supported by the format/protocol of the message, such as, for example, HTML or XML; inclusion in standard or user-defined message fields or headers, such as, for example in e-mails, X-AuthCode:, From:, To:, Subj: or Subject:, and others. When used in fields the authorization value may be required to adhere to a predefined syntax, such as, for example, “recipientid/AUTH=xxxx@domain.com”; or may be arbitrary; or may be delimited, such as, for example, “Subj: [AC:yyyy] This is the subject”; or other syntaxes; or no syntax. Such syntactic requirements may be user defined.

It is an additional advantage of the present invention that it enables multiple syntaxes and formats to be specified in message acceptance criteria involving authorization codes. Were a single format or syntax to be required on all arriving messages, eventually, spam senders would figure it out and be able, in many cases, to extract or derive true recipient addressing information from other addressing information having authorization data appended or embedded therein in a consistent way.

If an authorization value is required within the recipient's address, a corollary requirement in such an embodiment may be that the message-receiving system be programmed to accept addresses containing additional or substitute address information, as described more fully below.

FIG. 2b shows an exemplary flow regarding message acceptance in accordance with the present invention, wherein a number of tests, which may be defined among the associated acceptance criteria, or may be separate from the teachings of the present invention but integrated with them, may be performed prior (pre-tests 222) and/or subsequent (post-tests 226) to the meet-criteria test (224). Thereafter, appropriate acceptance 228 or rejection 230 processing may occur.

Various variations and permutations of the depicted serial flow will be apparent to one skilled in the art.

FIG. 2c shows an exemplary flow regarding message acceptance in accordance with the present invention, wherein tests regarding one or more applicable acceptance criteria occur in parallel with other tests, which results then are combined computationally (246). This computation may employ Boolean or other logical algorithms to weigh and/or combine the results of each criterion and/or each test, and/or to assign certain criteria and/or tests veto rights or override rights relative to other relevant criteria and/or tests. The computation's result may then be evaluated 248 to determine any subsequent acceptance 250 or rejection 252 processing, as described above, that should occur.

Tests regarding message acceptance criteria, and other tests, may also be applied in serial, parallel, and mixed serial-parallel combinations, a variety of which will be apparent to one skilled in the art.

FIG. 2d shows an exemplary flow regarding message acceptance in accordance with the present invention, wherein the meets criteria decision block 252 leads to a further check 254 as to whether one or more of the relevant criteria are, in fact, Template Criteria (as described above). If so, one or more Specific Criteria (as described above) may then be generated 256 in response to one or more of a plurality of attributes of, a plurality of elements of, and the contents of the message. The generation of the one or more Specific Criteria may involve accessing and/or modifying a criteria list or database 262, which may comprise, or be comprised of, one or more acceptance rules store(s) (FIG. 1a: 112, 1b: 146, 1c: 176).

When one or more Specific Criteria is generated 256, incomplete, wildcard, and/or templated information and/or parameters associated with the corresponding Template Criteria are substituted with more specific, complete, and/or precise information which may be drawn from the incoming message, and/or from other sources. For example, a Template Criterion may specify that an authorization code be present in the recipient's address portion of a message. An example might be “tom_{—}1234@mymail.com” in the To line of an e-mail message, with “tom@mymail.com” being the true recipient address (unknown to the sender), and “1234” being an authorization code, with “_” acting as a delimiter or separator. The authorization code may have been provided to the sender by the user, such as by entering “tom_{—}1234@mymail.com” on a sender's web-based order form, or by the inventive system. Were the applicable acceptance criterion a Self-Contained Criterion, then this authorization code 1234 might already be defined in a user profile within the inventive system and associated with the acceptance criterion as a parameter. The code might have been chosen by the user, or generated by the inventive system.

In various exemplary embodiments of the present invention, a Template Criterion may generate one or more Specific Criteria as a result of a plurality of actions having been associated with the Template Criterion, or without an explicit associated action as a result of the definition of the Template Criterion itself.

Each new Specific Criterion may then become part of one or more overall collections of criteria. A new Specific Criterion may have associated date- and/or time-related information inherited from the Template Criterion; for example, an expiration date 90 days from the arrival of the Triggering Message. It may also have narrowed parameters as compared with the Template Criterion; for example, applicability only to e-mail messages received from the Internet domain of the sender of the Triggering Message. Thus, the arrival of multiple Triggering Messages over time may create multiple concurrent instances of Specific Criteria, each of which may be associated with specific parameters that correspond to specific senders (or groups of senders, as via matching on their Internet domain), specific date- and/or time-limits, and other parameters and actions.

An aspect of an embodiment of the present invention which is of high utility is its capability of allowing an authorization value to remain unspecified in a message acceptance criterion until a Triggering Message arrives and defines the authorization value in the form of a generated Specific Criterion. For example, a user may communicate a recipient address to a prospective sender augmented by an authorization code, as per the example above (“tom_{—}1234@mymail.com”), but the user need never formally define the authorization code or the corresponding augmented recipient address to the inventive system. When the Triggering Message arrives and a corresponding Template Criterion, for example, includes wildcard-matching of an authorization code to be found between “_” and “@” in the recipient's address, a Specific Criterion may be generated which defines as an associated parameter the specific authorization code “1234”, preferably applicable either only to the specific sender of the Triggering Message, or to all senders from the same Internet domain (or other useful grouping). This Specific Criterion may also be date- and/or time-limited, such that this specific authorization code, which may have been invented by the user outside the operation of the inventive system, allows follow-up messages from the sender(s) who received the “1234” code-augmented recipient address to be delivered successfully to the actual recipient address at the recipient's own messaging system—at “tom@mymail.com” in this case—via the inventive system. If a relative expiration date is assigned in the generation of each subsequent Specific Criterion, then each new sender (or sender group) may be further individually limited in his/her/its ability to send additional messages to this recipient (using this authorization code) over time. His/her/its particular time-window may begin, for example, on the date the corresponding Triggering Message from that sender (or sender group) arrives, and end, for example, 90 days later.

The user may, after the fact, modify one or more of the generated Specific Criteria such that the permissions associated with such senders or sender groups are extended or reduced in time, or otherwise redefined or modified, or eliminated.

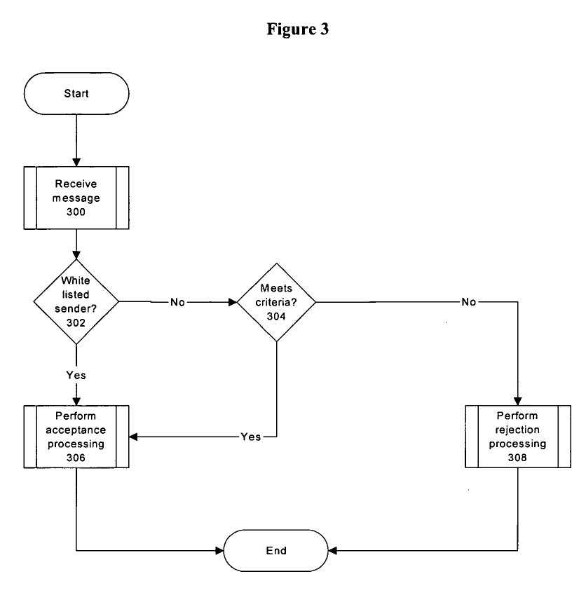

FIG. 3 shows an exemplary flow regarding message acceptance in accordance with the present invention, wherein a whitelist is consulted 302 prior to determining whether other acceptance criteria are met 304. The white list may comprise, or be comprised of, one or more acceptance rules stores (FIG. 1a: 112, 1b: 146, 1c: 176), which in turn may be integrated with, subsumed within, built upon or in, or replaced by external information stores, such as contact folders or databases, customer-relationship-management and supply-chain-management databases, address books, buddy lists, other databases, and other types of information stores.

In alternative exemplary embodiments, the whitelist may be incorporated in the meets criteria decision block 304 in the form of predetermined acceptance criteria, or the whitelist test 302 may occur in a different order relative to the meets criteria decision block 304.

By using one or more whitelists to bypass some or all other criteria in the treatment of incoming messages, a powerful multi-tiered spam-prevention solution may be implemented. A user may maintain one or more relatively short, manageable whitelists, for example to allow certain senders, such as friends, relatives, business associates, and the like, always to get their messages through. For messages not accepted based on the one or more whitelists, the user may establish a plurality of alternative or additional criteria such as, for example, the presence of a valid, non-expired authorization code, or the use of an augmented, modified or aliased recipient address including, or having qualities associated with, an authorization code. Such alternative or additional criteria may allow, for example, certain non-whitelist senders' messages to be accepted, such as messages from e-commerce vendors and information publishers from whom the user wishes to receive messages. This division of approaches to message acceptance allows the user to avoid revealing certain information, such as his/her true messaging address(es), to all potential senders, whether or not they are fully trusted by the user to use his/her address(es) solely for non-spam purposes or to keep his/her address(es) completely private. This model may be extended to an arbitrary number of tiers of acceptance criteria. All unaccepted messages under this scheme may, by default, be deemed and treated as spam.

To produce additional utility, the aforesaid plurality of alternative or additional criteria may further be comprised of, or otherwise be further associated with, a plurality of date- and/or time-related information, whereby the plurality of date- and/or time-related information serves to limit when the associated plurality of alternative or additional criteria apply. For example, a given authorization code may expire on a certain date or after a certain period of time. The expiration may be associated with a given authorization value, or with an authorization value in combination with another aspect or element of a message, such as its sender, its sender's organization (as may be defined by the sender's Internet domain name), key words in its subject or contents, and so on.

Even greater utility may be achieved by incorporating the concept of an authorization value into an augmented, modified, or aliased recipient address. The user may establish criteria which allow only whitelisted senders's messages, for example, to reach successfully one or more of his/her true message-receiving addresses. All other senders, for example, must use an augmented, modified, or aliased address, which address may further be associated, for example, with a general or sender-specific expiration date. In this way, the user may temporarily or permanently allow messages to be accepted from these non-whitelist senders without every compromising his/her true message-receiving addresses. The use of the whitelist by itself may stop acceptance of almost all spam messages. The use of alternative or additional criteria per this example allows additional senders (or other additional categories of messages, with or without regard to the sender), in a controlled manner, to get messages through, without compromising the recipient's true message receiving addresses.

A blacklist test may be substituted for the whitelist test 306 in FIG. 3, provided the “Yes” path from the blacklist test leads to rejection processing 308 instead of acceptance processing 305. A blacklist test may also occur in a different order relative to the meets criteria decision block 304 in alternative embodiments of the present invention.

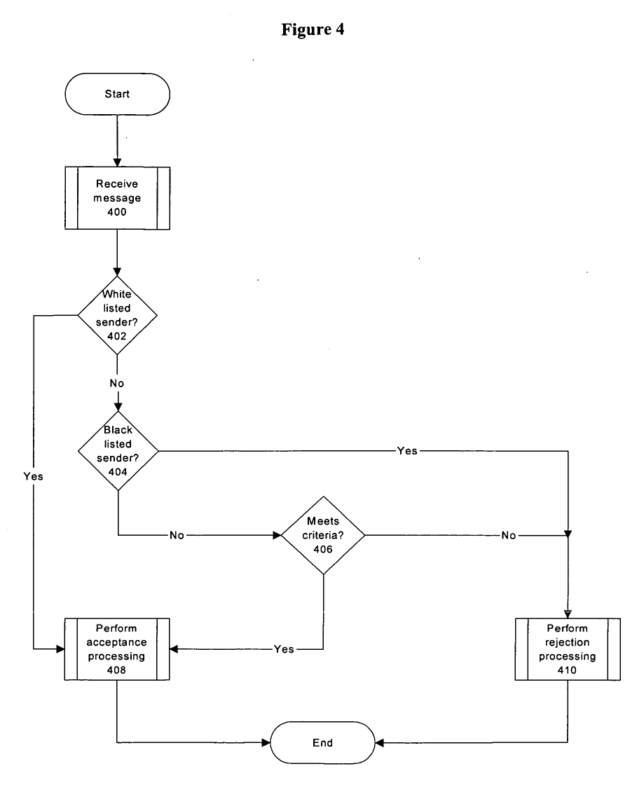

FIG. 4 shows an exemplary flow regarding message acceptance in accordance with the present invention, wherein both a whitelist test 402 and blacklist test 404 are performed serially. Such tests and the meets criteria decision block 406 may also be organized in differing sequences in alternative embodiments of the present invention.

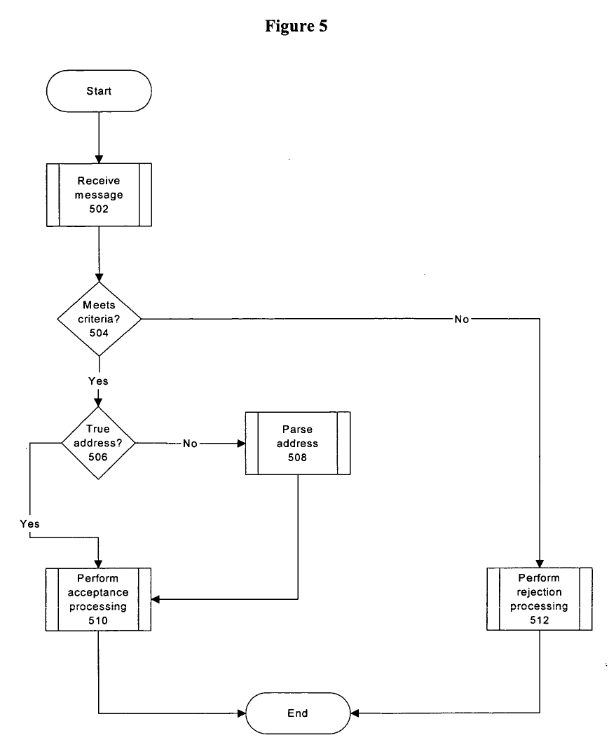

FIG. 5 shows an exemplary flow regarding message acceptance in accordance with the present invention, specifically for cases wherein an augmented or modified recipient address is used to convey acceptance-related information to the inventive system, whether or not the sender is aware that he/she/it is doing so. (That is, whether or not the sender realizes that the recipient address is an augmented or modified address and not a true recipient address.)

When a message arrives 502, and meets the relevant criteria 504 as previously described, for each of the plurality of recipient addresses associated with the message which is not a “true” address 506, the respective address is parsed or otherwise modified algorithmically 508 to obtain the corresponding “true” address for use in subsequent acceptance processing 510 as previously described. Messages failing to meet the relevant criteria 504 are subject to rejection processing 512 as previously described.

In an exemplary embodiment of a system in accordance with the present invention wherein an intermediary server (FIG. 1c: 162) is used, a message may have to be directed by its sender 184 not to the receiver's true address, but to the intermediary server 162 by using an augmented or otherwise modified, or a dummy or otherwise aliased, address, which address may have to include or otherwise incorporate the intermediary server's 162 address. One example of how this may be accomplished is by providing to prospective senders not the recipient's true address, nor even an authorization-value-modified variant of the recipient's true address, but an augmented address which incorporates or aliases an appropriate associated authorization value, the recipient's address, and also the intermediary's address.

For example, a user with an e-mail address of “myaddress@mydomain.com” using an embodiment of a system in accordance with the present invention operated as an intermediary data processing service having an address that includes an Internet domain of “intermediary.net”, may provide his/her address to a prospective sender as “myaddress:code%mydomain.com@intermediary.net”. (The use and placement of authorization information [“code”], delimiters “:” and “%”, etc., in this example are arbitrary.)

The message would arrive at the intermediary server 162 based on appropriate use of the intermediary's addressing information as part of the recipient's augmented address information. Then intermediary server 162 may then process the message based on its parsing 508 of the augmented address. Preferably, the intermediary server may then modify the message to “clean” it in regard to one or more recipient addresses, and then may transmit it to the one or more corresponding true recipient addresses, as part of acceptance processing 510.

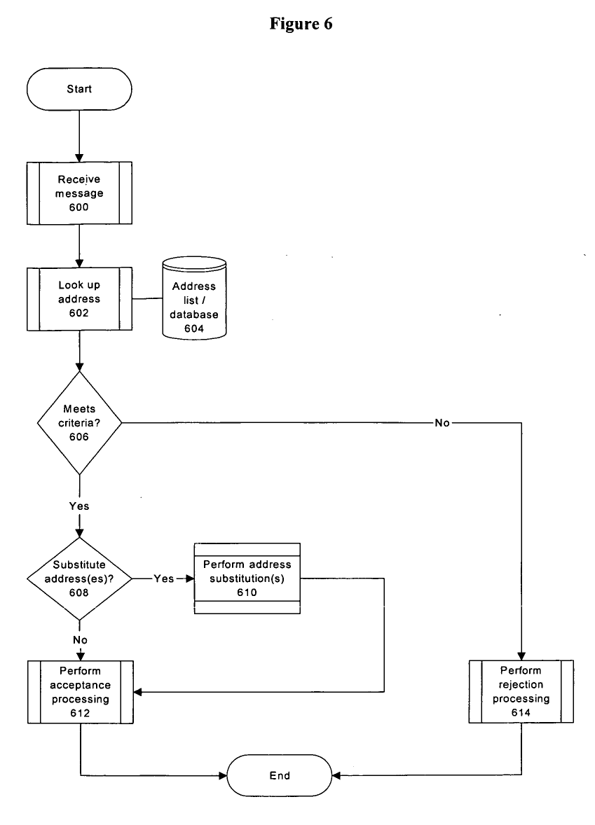

FIG. 6 shows an exemplary flow regarding message acceptance in accordance with the present invention, specifically for cases wherein an aliased or dummy recipient address is used to convey acceptance-related information to the inventive system, whether or not the sender is aware that he/she/it is doing so. (That is, whether or not the sender realizes that the recipient address is an aliased or dummy address and not a true recipient address.)

When a message arrives 600, a plurality of associated recipient addresses may be looked up 602 in a user address list or database 604, which may comprise, or be comprised of, one or more acceptance rules stores (FIG. 1a: 112, 1b: 146, 1c: 176) or one or more user information stores (FIG. 1b: 142, 1c: 173), or other information stores, files, memories or databases. The look-up 602 maps any aliased or dummy addresses to addresses which are either true recipient addresses or are addresses which are subsequently parseable or otherwise mutable into true recipient addresses. For example, a dummy address may map to a true address, and it may alternatively map to an address which is a true address augmented with an embedded temporary authorization code. For example, recipient address “mydummyaddress@mymail.net” may map to “tom@mymail.net” or, instead, to “tom:1234@mymail.net”, where the “:1234” may be parsed out by the exemplary system and used as an authorization value.

If the applicable acceptance criteria are met 606, each associated recipient address having a corresponding looked-up address 608 may undergo substitution of the corresponding looked-up address for the initial recipient address 610.

The message's original plurality of associated recipient addresses and/or a plurality of corresponding looked-up addresses may be considered in acceptance processing 612. As an example, a message to “mydummyaddress@mymail.net” may be mapped to “tom:1234@mymail.net”, may meet its plurality of criteria, which may include the presence of an authorization value of “1234” between the “:” and “1” in the mapped recipient address, and may then be delivered to a corresponding true recipient address, “tom@mymail.net”

By enabling the use of aliased or dummy addresses, an exemplary embodiment of a system in accordance with the present invention provides an added mechanism for protecting the privacy of a user's true recipient addresses, and thereby helps limit the opportunity for senders to direct spam to those addresses.

FIG. 7a depicts a portion of an exemplary user interface for an exemplary embodiment of a system in accordance with the present invention. In this example, a user's user ID 701, a list of (true) recipient addresses associated with the user ID and the message type of each 703; and a table of recent activity 705 relating to key events in the lifespans of some message acceptance criteria established by the user and/or by the inventive system, are shown. The first and third rows of the table 705 depict examples of Triggering Messages automatically generating Specific Criteria by virtue of the Triggering Messages' use of recipient addresses augmented with authorization values. Each of the exemplary Specific Criteria incorporates to a specific sender e-mail wildcard (*@[*.]estorecentral.biz, *@[*.]em02.ru), and shows, respectively, 90 and 59 remaining days until acceptance for each sender's messages (provided said messages use the appropriate respective augmented recipient address) expires.

The second row of the example table 705 shows the latest incidence of a non-whitelist, non-criteria-meeting message being discarded upon arrival, which may be in accordance with a default setting regarding the treatment of such messages.

The fourth and fifth rows of the example table 705 show the latest activity corresponding with two Self-Contained Criteria, respectively, both of which criteria had previously expired. A user, upon viewing similar rows, may thereby observe the continued transmission by various senders of messages which would previously have met acceptance criteria that have since expired.

FIG. 7b depicts another exemplary portion of a user interface for an exemplary embodiment of a system in accordance with the present invention. In this example, a user's user ID is shown, along with a hierarchy of associated criteria organized in a tree/branch structure by message type and, within message type, by increasing specificity of recipient address.

The in the first section of the example table (721), exemplary criteria related to acceptance of messages in general are displayed. In this example, no Specific Criteria have been defined at this topmost level, but certain exemplary default options are identified and may be modified by the user, such as whether messages directed specifically to the user's true recipient address(es) may be delivered there (here, No was selected), and what default actions should be taken by the inventive system upon rejecting a message (here, Discard and Log were selected).

The second example section (723) concerns e-mail message types in general, and presents information and default options similar to those of the first section 721. In an exemplary embodiment of a system according to the present invention, the default options from this section 723 may supersede those of the first section 721 for those messages where both sets can apply.

Also shown in the second example section (723) are depictions of two e-mail-specific Template Criteria and associated parameters, shown as “[To] Includes:*@” and “[To] Includes a1b2”, along with various associated actions. Exemplary date/time-limiting parameters are also associated, depicted respectively as “90d” and “60d”, which may indicate, for example, that any Specific Criteria generated from the Template Criteria upon receipt of a Triggering Message may have associated expirations of 90 and 60 days, respectively, from, for example, the date of arrival of the respective Triggering Message. The “Autoregister” designation accompanying each Template Criterion may be used, for example, to represent that the criterion is a Template Criterion. There is also an exemplary Self-Contained Criterion depicted, along with associated parameters including an expiration date, shown as “[To] Ends nospam” and “1 Sep. 2003”, and an associated action, “Fwd: van@mymail.com”, which may be representative of delivering accepted e-mail messages under this criterion to the address “van@mymail.com”.

The third example section (725) depicts certain exemplary default option settings for e-mails arriving for the specific recipient address of “van@mymail.net”, along with two exemplary Specific Criteria for e-mails arriving for that specific recipient address. In an exemplary embodiment of a system according to the present invention, the default options from this section 725 may supersede those of the first section 721 and second section 723 for those messages where either of both sets of higher-level options can apply.

The exemplary Specific Criteria are further specific to e-mail messages from sources matching, respectively, the Internet domain “estorecentral.biz”, shown as “*@[*.]estorecentral.biz” as representative of accommodating all senders and all subdomains of “estorecentral.biz”, and “em02.ru”, shown similarly as “*@[*.]em02.ru”. In each case, an explicit expiration associated with the specific sender domain is defined, and exemplary actions associated with message rejection processing are depicted.

The remaining sections 727, 729, 731, 733 of the example similarly depict exemplary default option selections and exemplary criteria relating to SMS messages (727, 729) and Instant Messages (731, 733). Section 729 is representative of a Self-Contained Criterion that, prior to Sep. 7, 2003, discards SMS messages whose recipient address does not begin with the character string “filt1”, and an exemplary default option setting that rejects SMS messages addressed directly to the recipient address. In this case the recipient address is defined as “van@mycellphone.com,” so the effect of which this section may be representative may therefore be: “van@mycellphone.com” does not accept SMS messages, but through Sep. 7, 2003, it was accepting SMS messages that were addressed, directly or indirectly, to “filt1van@mycellphone.com”. The corresponding exemplary embodiment may perform the address transformation and/or forwarding operation such that acceptable messages would, prior to Sep. 7, 2003, reach the true address of “van@mycellphone.com”.

In section 731, an example is presented that depicts an exemplary criterion whereby Instant Messages intended for this user's associated recipient IM addresses are blocked from any sender other than whose sender ID begins with “Maria”.

FIG. 7c depicts an exemplary e-mail message delivered to a recipient, wherein the example message has been modified by an embodiment of a system in accordance with the present invention. The exemplary modification includes changes to the message's headers 751, including the From field to identify the use of the augmented address “van:1234@mymail.net” by the sender, the To field to indicate the true recipient address as substituted by the inventive system, and changes to the body of the message 753, in this case the insertion of text indicative of this message having been a Triggering Message that has generated a corresponding Specific Criterion. The text may, for example, include information about the relevant Specific Criterion, such as one or more of its associated parameters, if any, which one or more parameters may include date- or time-related information, such as, in this example, an expiration date. In this example, the body of the original message follows 755.

A user, and/or an exemplary system in accordance with the present invention acting autonomously or under the direction of a user, may distribute from time to time information to a plurality of prospective senders that enables them to meet a plurality of predetermined message acceptance criteria.

For example, a user may define a criterion allowing a certain prospective sender's e-mail messages to be accepted provided a certain authorization value is included at the start of the Subject field of each e-mail message. The exemplary system may automatically distribute an appropriate authorization value to the prospective sender. Additionally or alternatively, it may issue one or more appropriate instructional messages to the prospective sender in regard to the new criterion. Additionally or alternatively, the user may, through the exemplary system, distribute an appropriate authorization value and/or one or more appropriate instructional messages to the prospective sender. Additionally or alternatively, the user may distribute an appropriate authorization value and/or one or more appropriate instructional messages to the prospective sender completely separate from the inventive system. When such values are distributed, they may be included within or accompanying an outgoing message, such as via an outgoing message's headers (for example, within a Reply-To header in an e-mail), in a Subject field, in the message body, in a custom header (for example, an e-mail X-AuthCode header), in an XML field or attachment, and various other formats and placements.

A user, and/or an exemplary system in accordance with the present invention acting autonomously or under the direction of a user, may distribute from time to time information regarding modifications, expirations, deletions, and other changes potentially relevant to a plurality of prospective senders in regard to a plurality of predetermined message acceptance criteria.

An exemplary embodiment of a system in accordance with the present invention may include certain options and default settings which help govern the behavior of the system. Such options and default setting may be user-defined. Among such options and default settings may be
the number of user profiles that may be associated with a given user;
the number of (true) recipient addresses which may be associated with a given user profile;
the number of authorization values which may be associated with a given user profile or with a given recipient address;
the number of aliased, dummy, augmented, or otherwise modified or substitutable addresses which may be associated with a given user profile or with a given recipient address;
the allowable length of authorization values;
the allowed parsing and/or syntactic rules applicable to the use of authentication values and/or augmented or otherwise modified recipient addresses;
whether all authentication values must be predetermined, or whether one or more may instead become extant by being detected in an incoming message;
whether senders with Internet-style sending addresses should by default have domains match exactly (for example, “f123@xy.com” does not match exactly “f123@a.xy.com”), or a first-level match is close enough (“f123@xy.com” matches “f123@a.xy.com” but not “f123@a.bc.com”)’;
the expiration duration to be associated with new Specific Criteria, for example, 90 days for a given new sender upon its first use of a given authorization value or equivalent alias recipient address;
whether an autoresponse message should be sent in response to non-accepted messages, and whether this should occur on a per-message, per-sender, or other basis;
how such an autoresponse message should formatted, and with what default content;
whether un-accepted messages should be quarantined permanently, temporarily, or not at all;
whether messages may ever be accepted to a true recipient address from non-whitelist sources; and
whether messages that do not explicitly identify a known recipient address may ever be accepted.
   Many other default settings and options will be apparent to one skilled in the art; the above list is exemplary and not intended to be limiting.

Although the present invention has been described in relation to particular embodiments thereof, many other variations and modifications and other uses will become apparent to those skilled in the art. Therefore, the present invention is not limited by the specific disclosure herein.

1. A method for maintaining a list of one or more items of information to be considered in the processing of an incoming electronic message, comprising the steps of:
determining whether an incoming electronic message meets one or more predetermined criteria associated with one or more aspects and/or elements of the message and with a plurality of items of information from one or more lists; and
altering the one or more lists by one or more of modifying, deleting, and adding a plurality of items of information;
wherein the step of altering is based on one or more of a) the result of the step of determining, b) the one or more predetermined criteria, c) one or more items of information from the one or more lists, d) information contained in the incoming electronic message, and e) information associated with the incoming electronic message;
and wherein the plurality of items of information modified, deleted or added has one or more associated expirations, and is related to one or more of a) the identity of the sender of the incoming electronic message and b) at least one of a plurality of recipient addresses associated with the incoming electronic message.

2. The method of claim 1, wherein the one or more lists include one or more items of information related to one or more pre-authorized senders of incoming electronic messages.

3. The method of claim 1, wherein the one or more lists are comprised of one or more of an authorized sender list, an unauthorized sender list, an electronic directory, an electronic address book, a buddy list, a contact list, a contact folder, and a contact database.

4. The method of claim 1, wherein the one or more lists include one or more items of information related to one or more authorization codes.

5. The method of claim 4, wherein the plurality of items of information modified, deleted or added associates information related to the identity of the sender of the incoming electronic message with the one or more authorization codes.

6. The method of claim 4, wherein the plurality of items of information modified, deleted or added associates information related to at least one of a plurality of recipient addresses of the incoming electronic message with the one or more authorization codes.

7. The method of claim 1, wherein the plurality of items of information modified, deleted or added associates information related to the identity of the sender of the incoming electronic message with information related to at least one of a plurality of recipient addresses of the incoming electronic message.

8. The method of claim 1, wherein the one or more lists include one or more items of information related to one or more recipient addresses for incoming electronic messages.

9. The method of claim 8, wherein at least one of the one or more recipient addresses is one or more of an augmented address and an aliased address.

10. The method of claim 9, further comprising the step of substituting at least one true recipient address for the at least one of the one or more recipient addresses that is one or more of an augmented address and an aliased address.

11. The method of claim 8, wherein the plurality of items of information modified, deleted or added associates information related to the identity of the sender of the incoming electronic message with the one or more recipient addresses.

12. The method of claim 8, wherein the plurality of items of information modified, deleted or added associates information related to the identity of the sender of the incoming electronic message with one or more authorization codes associated with the one or more recipient addresses.

13. The method of claim 1, wherein the one or more predetermined criteria are one or more of:
a) sender identification information matches a predetermined value from the one or more lists;
b) a specified portion of the sender identification information matches a predetermined value from the one or more lists;
c) sender identification information matches a predetermined string from the one or more lists containing a plurality of wildcard characters;
d) a specified portion of the sender identification information matches a predetermined string from the one or more lists containing a plurality of wildcard characters;
e) a valid authorization code from the one or more lists is present;
f) a valid authorization code from the one or more lists occupies a specific field of the incoming electronic message;
g) a valid authorization code from the one or more lists is contained within a specific field of the incoming electronic message;
h) recipient addressing information matches a predetermined value from the one or more lists;
i) a portion of the recipient addressing information matches a predetermined value from the one or more lists;
j) recipient identification information matches a predetermined string from the one or more lists containing a plurality of wildcard characters; and
k) a portion of the recipient addressing information matches a predetermined string from the one or more lists containing a plurality of wildcard characters.

14. The method of claim 1, wherein the incoming electronic message comprises one or more of an e-mail message, an instant message, a wireless text message, a wireless data message, an SMS message, a pager message, a Voice over Internet Protocol (VoIP) voice call, a VoIP voice message, an RDF Site Summary (RSS) message, a Hypertext Transfer Protocol (HTTP) message, and a web services message.

15. The method of claim 1, further comprising the step of modifying one or more of the content and the addressing of the incoming electronic message.

16. The method of claim 1, further comprising the steps of:
defining a plurality of criteria to be used in the step of determining;
compiling one or more lists of one or more items of information to be considered in one or more of the steps of determining and altering; and
storing one or more of a) the plurality of criteria and b) at least one of the one or more lists in one or more user profiles.

17. A method of controlling receipt of an incoming electronic message comprising the steps of:
determining whether an incoming electronic message meets one or more predetermined criteria associated with one or more aspects and/or elements of the message and with a plurality of items of information from one or more lists;
processing the incoming electronic message based on the result of the step of determining; and
altering the one or more lists by one or more of modifying, deleting and adding a plurality of items of information;
wherein the step of altering is based on one or more of a) the result of the step of determining, b) the one or more predetermined criteria, c) one or more items of information from the one or more lists, d) information contained in the incoming electronic message, and e) information associated with the incoming electronic message;
and wherein the plurality of items of information modified, deleted or added has one or more associated expirations, and is related to one or more of a) the identity of the sender of the incoming electronic message and b) at least one of a plurality of recipient addresses associated with the incoming electronic message.

18. The method of claim 17, wherein the one or more lists include one or more items of information related to one or more pre-authorized senders of incoming electronic messages.

19. The method of claim 17, wherein the one or more lists are comprised of one or more of an authorized sender list, an unauthorized sender list, an electronic directory, an electronic address book, a buddy list, a contact list, a contact folder, and a contact database.

20. The method of claim 17, wherein the one or more lists include one or more items of information related to one or more authorization codes.

21. The method of claim 20, wherein the plurality of items of information modified, deleted or added associates information related to the identity of the sender of the incoming electronic message with the one or more authorization codes.

22. The method of claim 20, wherein the plurality of items of information modified, deleted or added associates information related to at least one of a plurality of recipient addresses of the incoming electronic message with the one or more authorization codes.

23. The method of claim 17, wherein the plurality of items of information modified, deleted or added associates information related to the identity of the sender of the incoming electronic message with information related to at least one of a plurality of recipient addresses of the incoming electronic message.

24. The method of claim 17, wherein the one or more lists include one or more items of information related to one or more recipient addresses for incoming electronic messages.

25. The method of claim 24, wherein at least one of the one or more recipient addresses is one or more of an augmented address and an aliased address.

26. The method of claim 25, further comprising the step of substituting at least one true recipient address for the at least one of the one or more recipient addresses that is one or more of an augmented address and an aliased address.

27. The method of claim 24, wherein the plurality of items of information modified, deleted or added associates information related to the identity of the sender of the incoming electronic message with the one or more recipient addresses.

28. The method of claim 24, wherein the plurality of items of information modified, deleted or added associates information related to the identity of the sender of the incoming electronic message with one or more authorization codes associated with the one or more recipient addresses.

29. The method of claim 17, wherein the one or more predetermined criteria are one or more of:
a) sender identification information matches a predetermined value from the one or more lists;
b) a specified portion of the sender identification information matches a predetermined value from the one or more lists;
c) sender identification information matches a predetermined string from the one or more lists containing a plurality of wildcard characters;
d) a specified portion of the sender identification information matches a predetermined string from the one or more lists containing a plurality of wildcard characters;
e) a valid authorization code from the one or more lists is present;
f) a valid authorization code from the one or more lists occupies a specific field of the incoming electronic message;
g) a valid authorization code from the one or more lists is contained within a specific field of the incoming electronic message;
h) recipient addressing information matches a predetermined value from the one or more lists;
i) a portion of the recipient addressing information matches a predetermined value from the one or more lists;
j) recipient identification information matches a predetermined string from the one or more lists containing a plurality of wildcard characters; and
k) a portion of the recipient addressing information matches a predetermined string from the one or more lists containing a plurality of wildcard characters.

30. The method of claim 17, wherein the incoming electronic message comprises one or more of an e-mail message, an instant message, a wireless text message, a wireless data message, an SMS message, a pager message, a Voice over Internet Protocol (VoIP) voice call, a VoIP voice message, an RDF Site Summary (RSS) message, a Hypertext Transfer Protocol (HTTP) message, and a web services message.

31. The method of claim 17, further comprising the step of modifying one or more of the content and the addressing of the incoming electronic message.

32. The method of claim 17, further comprising the steps of:
defining a plurality of criteria to be used in the step of determining;
compiling one or more lists of one or more items of information to be considered in one or more of the steps of determining and altering; and
storing one or more of a) the plurality of criteria and b) at least one of the one or more lists in one or more user profiles.

33. A system for controlling receipt of electronic messages comprising
one or more computing elements;
one or more memories; and
programming code residing in the one or more memories;
wherein the programming code directs the one or more computing elements to perform steps comprised of:
determining whether an incoming electronic message meets one or more predetermined criteria associated with one or more aspects and/or elements of the message and with a plurality of items of information from one or more lists, the one or more lists residing in the one or more memories;
processing the incoming electronic message based on the result of the step of determining; and
altering the one or more lists by one or more of modifying, deleting, and adding a plurality of items of information;
wherein the step of altering is based on one or more of a) the result of the step of determining, b) the one or more predetermined criteria, c) one or more items of information from the one or more lists, d) information contained in the incoming electronic message, and e) information associated with the incoming electronic message;
and wherein the plurality of items of information modified, deleted or added has one or more associated expirations, and is related to one or more of a) the identity of the sender of the incoming electronic message and b) at least one of a plurality of recipient addresses associated with the incoming electronic message.

34. The system of claim 33, wherein the one or more lists include one or more items of information related to one or more pre-authorized senders of incoming electronic messages.

35. The system of claim 33, wherein the one or more lists are comprised of one or more of an authorized sender list, an unauthorized sender list, an electronic directory, an electronic address book, a buddy list, a contact list, a contact folder, and a contact database.

36. The system of claim 33, wherein the one or more lists include one or more items of information related to one or more authorization codes.

37. The system of claim 33, wherein the plurality of items of information modified, deleted or added associates information related to the identity of the sender of the incoming electronic message with the one or more authorization codes.

38. The system of claim 33, wherein the plurality of items of information modified, deleted or added associates information related to at least one of a plurality of recipient addresses of the incoming electronic message with the one or more authorization codes.

39. The system of claim 33, wherein the plurality of items of information modified, deleted or added associates information related to the identity of the sender of the incoming electronic message with information related to at least one of a plurality of recipient addresses of the incoming electronic message.

40. The system of claim 33, wherein the one or more lists include one or more items of information related to one or more recipient addresses for incoming electronic messages.

41. The system of claim 40, wherein at least one of the one or more recipient addresses is one or more of an augmented address and an aliased address.

42. The system of claim 41, further comprising the step of substituting at least one true recipient address for the at least one of the one or more recipient addresses that is one or more of an augmented address and an aliased address.

43. The system of claim 40, wherein the plurality of items of information modified, deleted or added associates information related to the identity of the sender of the incoming electronic message with the one or more recipient addresses.

44. The method of claim 40, wherein the plurality of items of information modified, deleted or added associates information related to the identity of the sender of the incoming electronic message with one or more authorization codes associated with the one or more recipient addresses.

45. The system of claim 33, wherein the one or more predetermined criteria are one or more of:
a) sender identification information matches a predetermined value from the one or more lists;
b) a specified portion of the sender identification information matches a predetermined value from the one or more lists;
c) sender identification information matches a predetermined string from the one or more lists containing a plurality of wildcard characters;
d) a specified portion of the sender identification information matches a predetermined string from the one or more lists containing a plurality of wildcard characters;
e) a valid authorization code from the one or more lists is present;
f) a valid authorization code from the one or more lists occupies a specific field of the incoming electronic message;
g) a valid authorization code from the one or more lists is contained within a specific field of the incoming electronic message;
h) recipient addressing information matches a predetermined value from the one or more lists;
i) a portion of the recipient addressing information matches a predetermined value from the one or more lists;
j) recipient identification information matches a predetermined string from the one or more lists containing a plurality of wildcard characters; and
k) a portion of the recipient addressing information matches a predetermined string from the one or more lists containing a plurality of wildcard characters.

46. The system of claim 33, wherein the programming code directs the one or more computing elements to combine the one or more predetermined criteria using one or more of Boolean algebra, matrix algebra, and one or more deterministic algorithms, within the step of determining.

47. The system of claim 33, wherein the incoming electronic message comprises one or more of an e-mail message, an instant message, a wireless text message, a wireless data message, an SMS message, a pager message, a Voice over Internet Protocol (VoIP) voice call, a VoIP voice message, an RDF Site Summary (RSS) message, a Hypertext Transfer Protocol (HTTP) message, and a web services message.

48. The system of claim 33, further comprising the step of modifying one or more of the content and the addressing of the incoming electronic message.

49. The system of claim 33, further comprising one or more user profiles, wherein the programming code directs the one or more computing elements to perform the further steps of:
compiling a plurality of criteria to be used in the step of determining;
compiling one or more lists of one or more items of information to be considered in one or more of the steps of determining and altering; and
storing one or more of the plurality of criteria and the one or more lists in one or more user profiles.

50. The system of claim 33, wherein one or more of the plurality of criteria and the one or more lists are automatically modified based upon one or more of a) one or more of the characteristics, state, parameters and contents of an incoming electronic message, b) one or more of the plurality of criteria, and c) one or more of the items of information contained in the one or more lists.

51. The system of claim 33, further comprising a user interface that allows a user to modify the contents of the one or more memories under the control of the programming code.

52. The system of claim 51, wherein the user interface is remotely accessible by a user via one or more of the Internet, a telephone, a mobile communications device, and a mobile computing device.

53. The system of claim 33, further comprising an acceptance handler module that performs one or more of the steps of determining and altering on one or more of a scheduled basis, an ad hoc basis, an event-driven basis, and as directed by a user through a user interface.

54. The system of claim 33, further comprising an acceptance handler module that performs the additional step of modifying the incoming electronic message.

55. The system of claim 54, wherein the step of modifying includes substituting at least one true recipient address for at least one recipient addresses that is one or more of an augmented address and an aliased address.

56. The system of claim 33, further comprising an autoresponder module that generates a plurality of outgoing electronic messages associated with the step of processing.

57. The system of claim 33, wherein the one or more memories further store one or more of logs of system activities, copies of electronic messages, user-related information, and security-related information.

58. The system of claim 33, wherein the programming code is configured to direct the one or more computing elements to perform one or more of the further steps of conducting acceptance pretests and conducting acceptance post-tests, in series with the step of determining, regarding an incoming electronic message, the results of which tests are considered in one or more of the steps of processing and altering.

59. The system of claim 33, wherein the programming code is configured to direct the one or more computing elements to perform the further step of conducting one or more supplemental acceptance tests, in parallel with the step of determining, regarding an incoming electronic message, the results of which tests are considered in one or more of the steps of processing and altering.

60. The system of claim 33, wherein the step of processing is further comprised of one or more of the sub-steps of accepting, categorizing, routing, forwarding, readdressing, storing, archiving, replying to, responding to, rejecting, flagging, logging, quarantining, altering, deleting, and discarding one or more of a) the incoming electronic message, b) information associated with the electronic message, and c) one or more of the characteristics, state, parameters and contents of the electronic message.
